(19) United States
(12) Patent Application Publication
(10) Pub. No.: US 2024/0072975 A1
(43) Pub. Date: Feb. 29, 2024

(54) Transmitting Pending Feedback Information

(71) Applicant: Ofinno, LLC, Reston, VA (US)

(72) Inventors: Nazanin Rastegardoost, McLean, VA (US); Yunjung Yi, Vienna, VA (US); Esmael Hejazi Dinan, McLean, VA (US)

(73) Assignee: Ofinno, LLC, Reston, VA (US)

(21) Appl. No.: 18/502,609

(22) Filed: Nov. 6, 2023

Related U.S. Application Data
(63) Continuation of application No. PCT/US2022/028103, filed on May 6, 2022.
(60) Provisional application No. 63/185,132, filed on May 6, 2021.

(51) Int. Cl. H04L 5/00; H04W 72/20

(52) U.S. Cl. CPC H04L 5/0053; H04W 72/20

(57) ABSTRACT

A wireless device receives, via a first control resource set (coreset) pool of a plurality of coreset pools, a first downlink control information (DCI) indicating no feedback timing for transmission of feedback information of the first DCI. The wireless device receives a second DCI indicating a first physical uplink control channel (PUCCH). The wireless device transmits the feedback information of the first DCI via the first PUCCH, based on the first PUCCH being associated with the first coreset pool via which the first DCI is received.

### CROSS-REFERENCE TO RELATED APPLICATIONS

This application is a continuation of International Application No. PCT/US2022/028103, filed May 6, 2022, which claims the benefit of U.S. Provisional Application No. 63/185,132, filed May 6, 2021, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 illustrates an example of HARQ feedback timing determination, according to some embodiments.

FIG. 18 illustrates an example of grouping PDSCHs using scheduling DCIs, according to some embodiments.

FIG. 19 illustrates an example of grouping PDSCHs using scheduling DCIs, according to some embodiments.

FIG. 20 illustrates an example of HARQ-ACK transmission associated with a DCI scheduling multiple PDSCHs, according to some embodiments.

FIG. 21 illustrates an example of transmitting a pending HARQ feedback information, according to some embodiments.

FIG. 22 illustrates as example of a DCI triggering multiple PUCCH transmissions, according to some embodiments.

FIG. 23 illustrates an example of PUCCH selection for a pending HARQ feedback transmission, according to some embodiments.

FIG. 24 illustrates an example of PUCCH selection for a pending HARQ feedback transmission in a carrier aggregation scenario, according to some embodiments.

FIG. 25 illustrates an example of PUCCH selection for a pending HARQ feedback transmission with multiple applicable HARQ-AKC codebooks, according to some embodiments.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

Abase station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

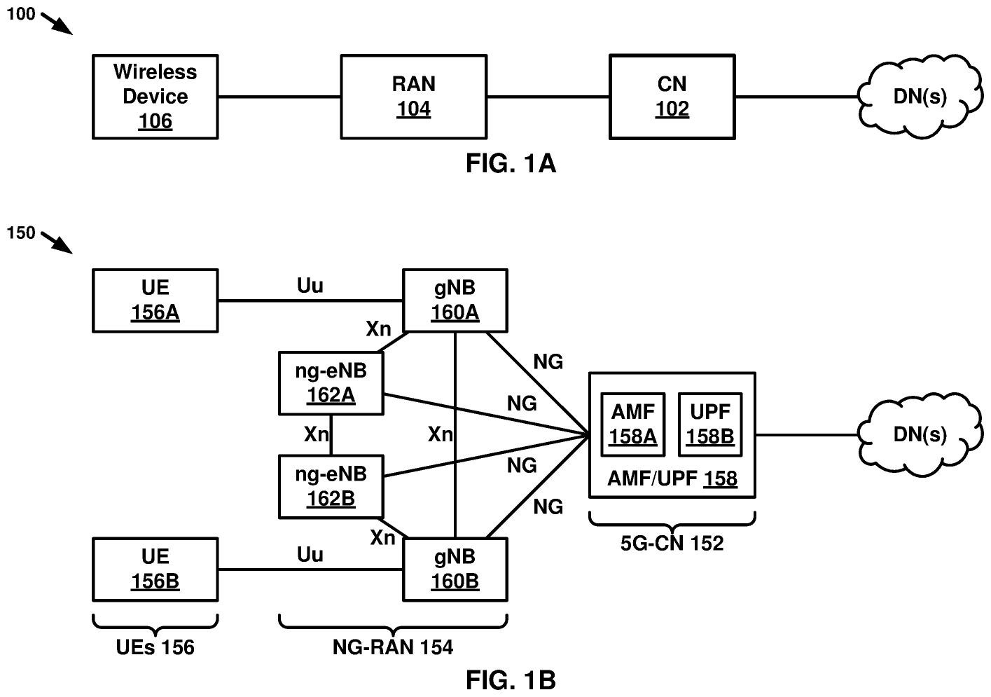

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNs (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, WiFi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNs (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

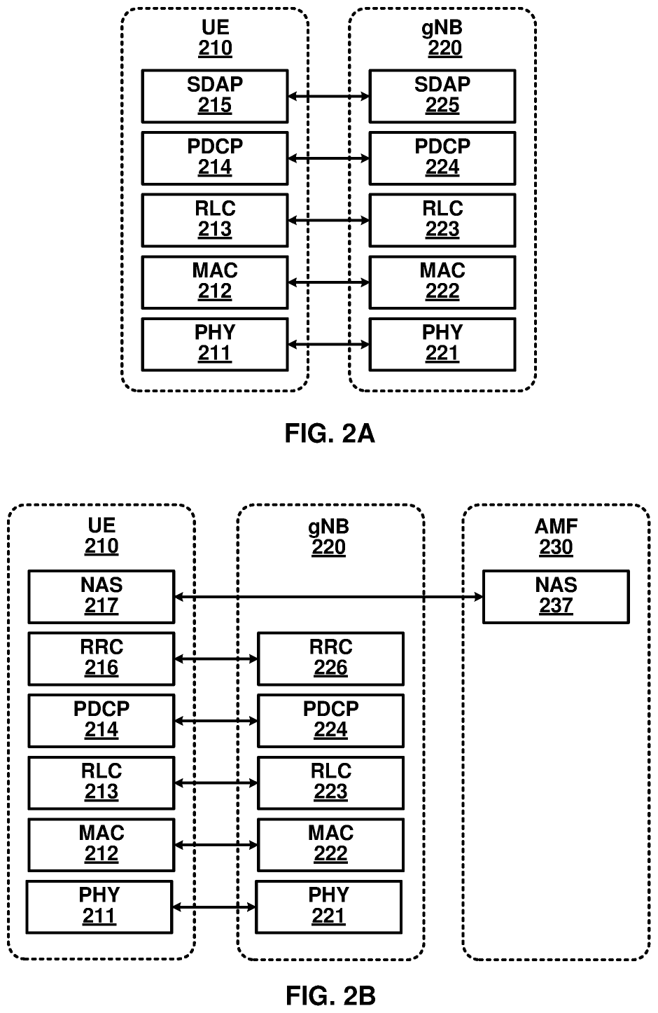

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

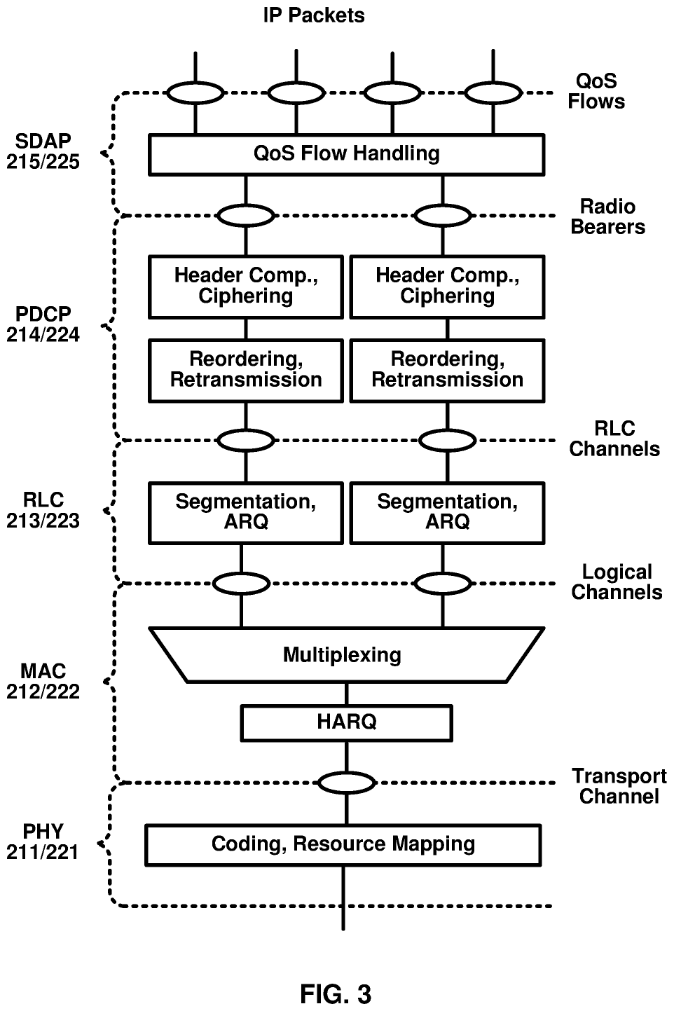

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

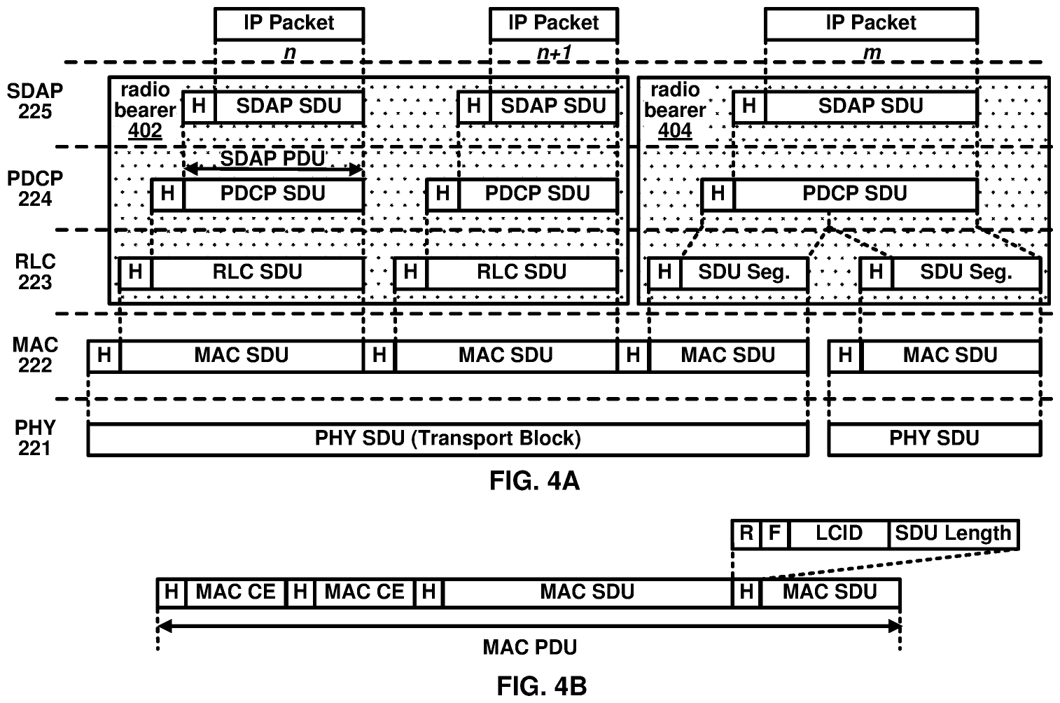

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

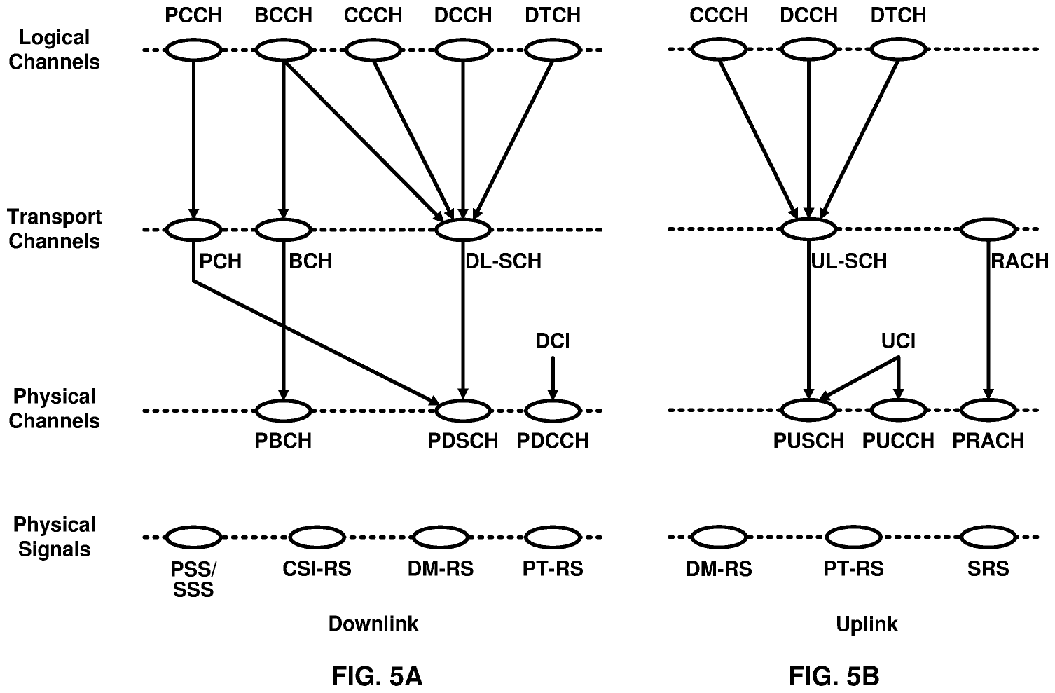

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

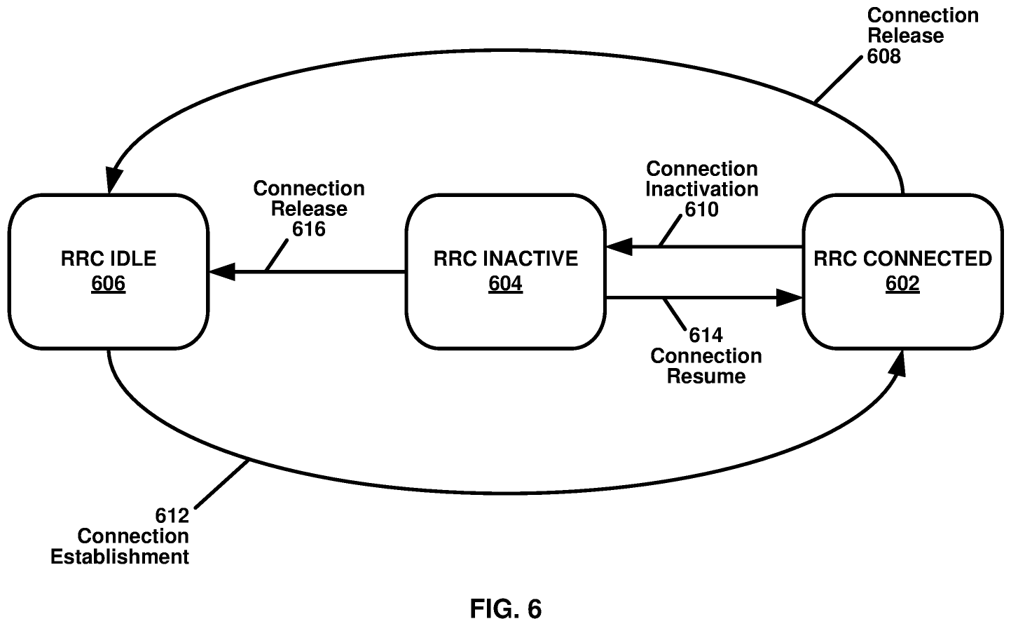

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAls, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split in two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

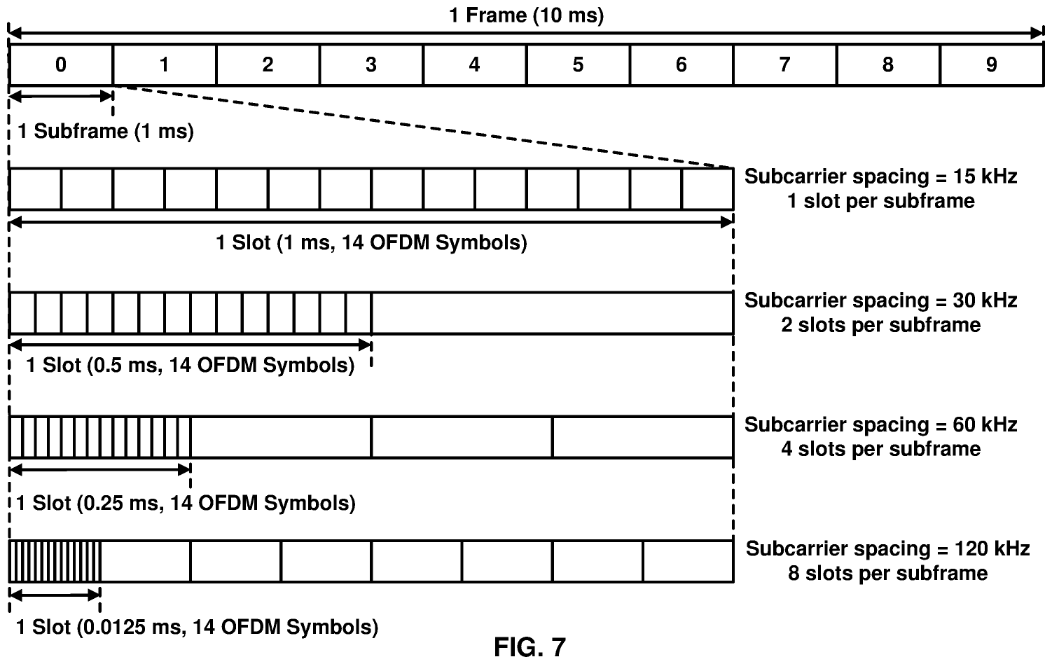

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 kHz/2.3 μs; 60 kHz/1.2 μs; 120 kHz/0.59 μs; and 240 kHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

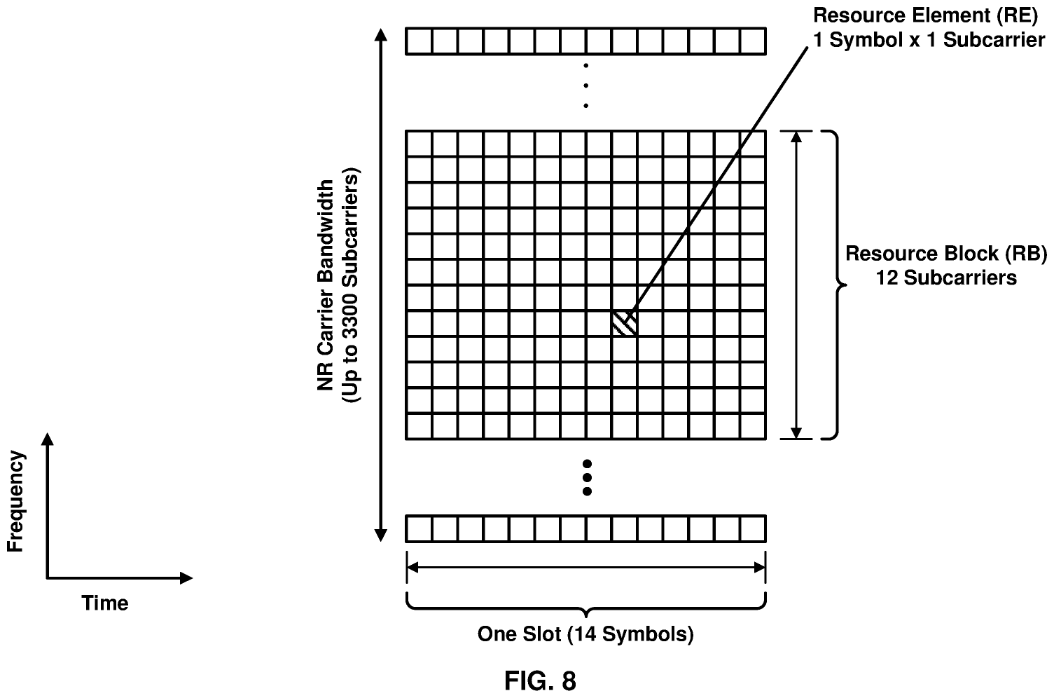

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), abase station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

Abase station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

Abase station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, abase station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

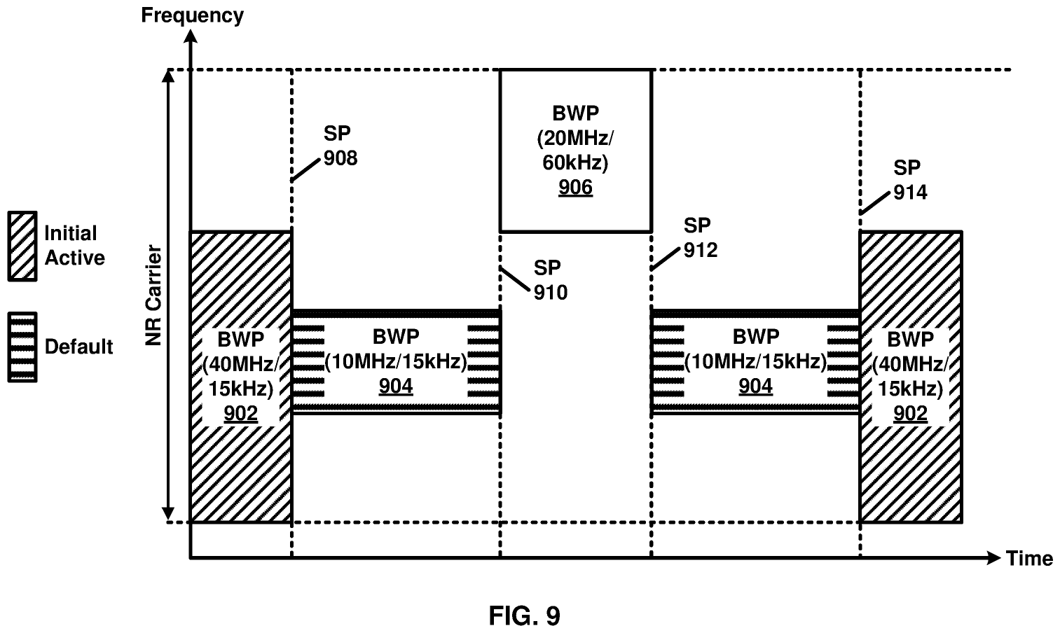

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response receiving a DCI indicating BWP 906 as the active BWP. The UE may switch at a switching point 912 from active BWP 906 to BWP 904 in response to an expiry of a BWP inactivity timer and/or in response receiving a DCI indicating BWP 904 as the active BWP. The UE may switch at a switching point 914 from active BWP 904 to BWP 902 in response receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

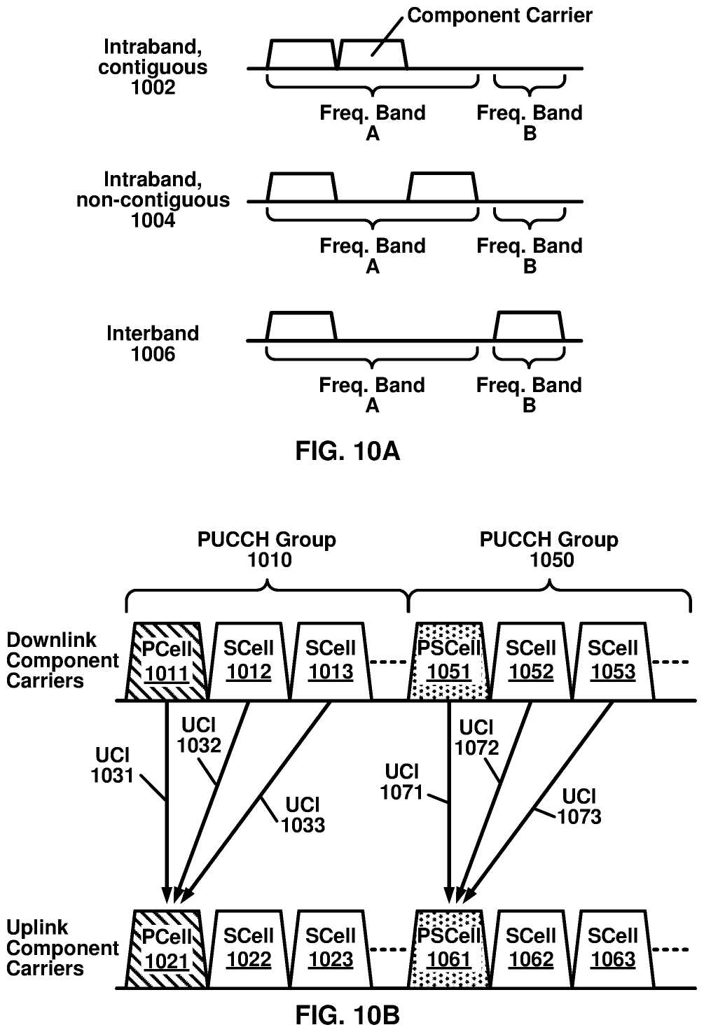

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary Scell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

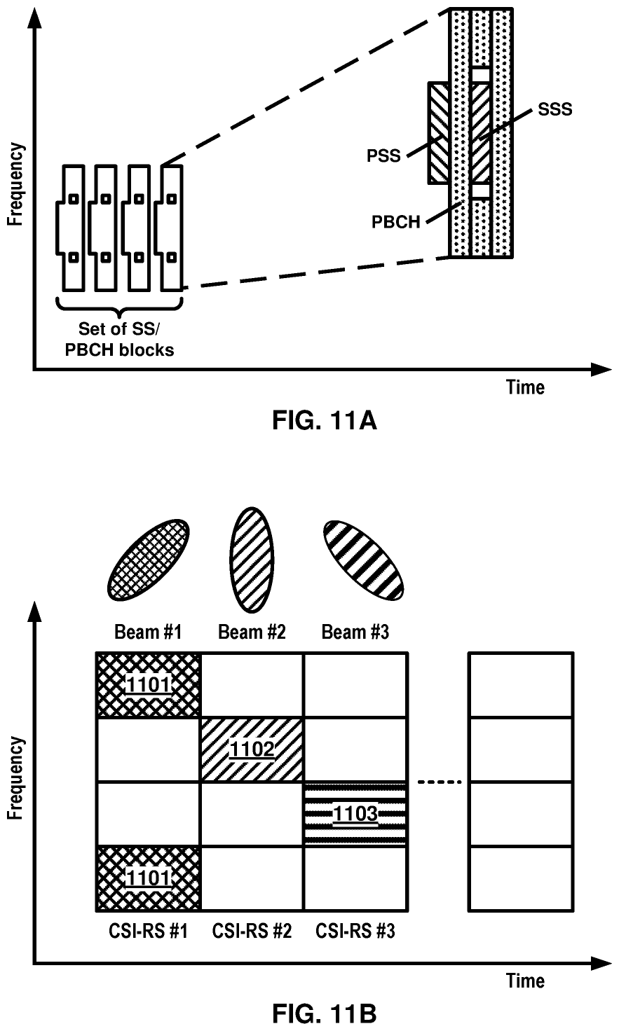

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in a SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

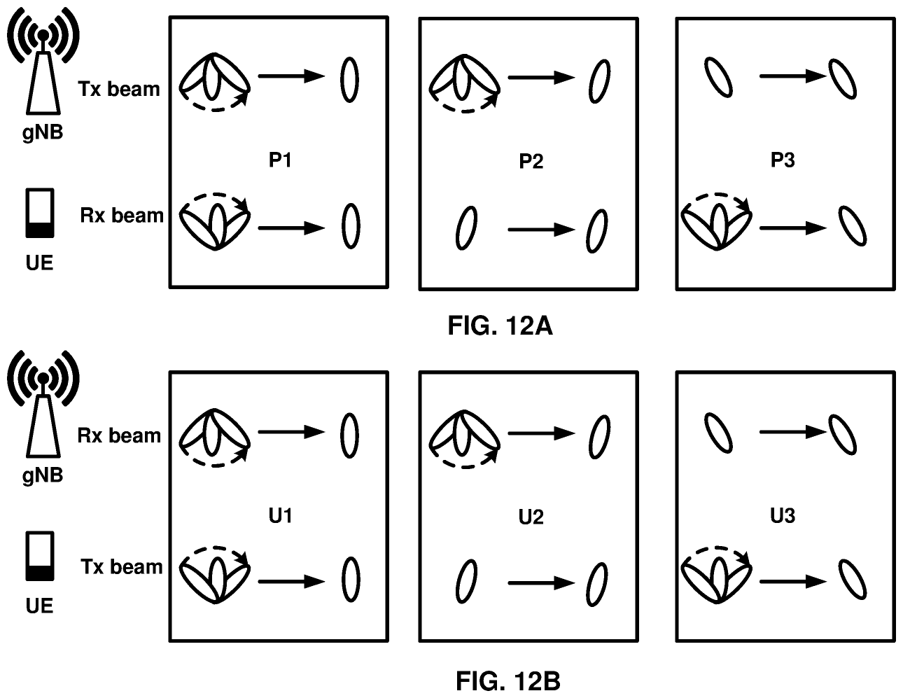

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counter-clockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counter-clockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counter-clockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality ofa beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

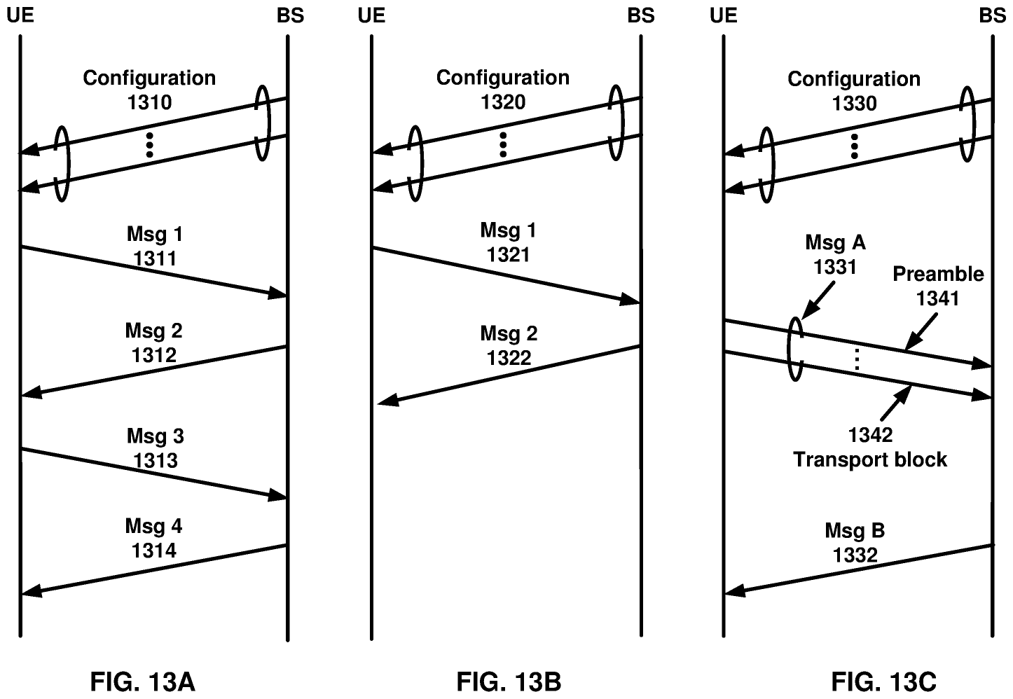

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 11311, a Msg 21312, a Msg 31313, and a Msg 41314. The Msg 11311 may include and/or be referred to as a preamble (or a random access preamble). The Msg 21312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 11311 and/or the Msg 31313. Based on the one or more RACH parameters, the UE may determine a reception timing and a downlink channel for receiving the Msg 21312 and the Msg 41314.

The one or more RACH parameters provided in the configuration message 1310 may indicate one or more Physical RACH (PRACH) occasions available for transmission of the Msg 11311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 11311 and/or Msg 31313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 11311 and the Msg 31313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 11311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 31313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 31313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 11311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 21312 received by the UE may include an RAR. In some scenarios, the Msg 21312 may include multiple RARs corresponding to multiple UEs. The Msg 21312 may be received after or in response to the transmitting of the Msg 1 1311. The Msg 21312 may be scheduled on the DL-SCH and indicated on a PDCCH using a random access RNTI (RA-RNTI). The Msg 21312 may indicate that the Msg 11311 was received by the base station. The Msg 21312 may include a time-alignment command that may be used by the UE to adjust the UE's transmission timing, a scheduling grant for transmission of the Msg 31313, and/or a Temporary Cell RNTI (TC-RNTI). After transmitting a preamble, the UE may start a time window (e.g., ra-ResponseWindow) to monitor a PDCCH for the Msg 21312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id
where s_id may be an index of a first OFDM symbol of the PRACH occasion (e.g., 0≤s_id<14), t_id may be an index of a first slot of the PRACH occasion in a system frame (e.g., 0≤t_id<80), fid may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).
   The UE may transmit the Msg 31313 in response to a successful reception of the Msg 21312 (e.g., using resources identified in the Msg 21312). The Msg 31313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 41314) may be used to increase the likelihood that the UE does not incorrectly use an identity of another the UE. To perform contention resolution, the UE may include a device identifier in the Msg 31313 (e.g., a C-RNTI if assigned, a TC-RNTI included in the Msg 21312, and/or any other suitable identifier).

The Msg 41314 may be received after or in response to the transmitting of the Msg 31313. If a C-RNTI was included in the Msg 31313, the base station will address the UE on the PDCCH using the C-RNTI. If the UE's unique C-RNTI is detected on the PDCCH, the random access procedure is determined to be successfully completed. If a TC-RNTI is included in the Msg 31313 (e.g., if the UE is in an RRC_IDLE state or not otherwise connected to the base station), Msg 41314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 31313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 31313) may remain on the selected carrier. The UE may switch an uplink carrier during the random access procedure (e.g., between the Msg 11311 and the Msg 31313) in one or more cases. For example, the UE may determine and/or switch an uplink carrier for the Msg 11311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 21322. The Msg 11321 and the Msg 21322 may be analogous in some respects to the Msg 11311 and a Msg 21312 illustrated in FIG. 13A, respectively. As will be understood from FIGS. 13A and 13B, the contention-free random access procedure may not include messages analogous to the Msg 31313 and/or the Msg 41314.

The contention-free random access procedure illustrated in FIG. 13B may be initiated for a beam failure recovery, other SI request, SCell addition, and/or handover. For example, a base station may indicate or assign to the UE the preamble to be used for the Msg 11321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 11321 and reception of a corresponding Msg 21322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 31313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 21312 (e.g., an RAR) illustrated in FIGS. 13A and 13B and/or the Msg 41314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 00 may be used for scheduling of PUSCH in a cell. DCI format 00 may be a fallback DCI format (e.g., with compact DCI payloads). DCI format 01 may be used for scheduling of PUSCH in a cell (e.g., with more DCI payloads than DCI format 0_0). DCI format 10 may be used for scheduling of PDSCH in a cell. DCI format 10 may be a fallback DCI format (e.g., with compact DCI payloads). DCI format 11 may be used for scheduling of PDSCH in a cell (e.g., with more DCI payloads than DCI format 1_0). DCI format 20 may be used for providing a slot format indication to a group of UEs. DCI format 21 may be used for notifying a group of UEs of a physical resource block and/or OFDM symbol where the UE may assume no transmission is intended to the UE. DCI format 22 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

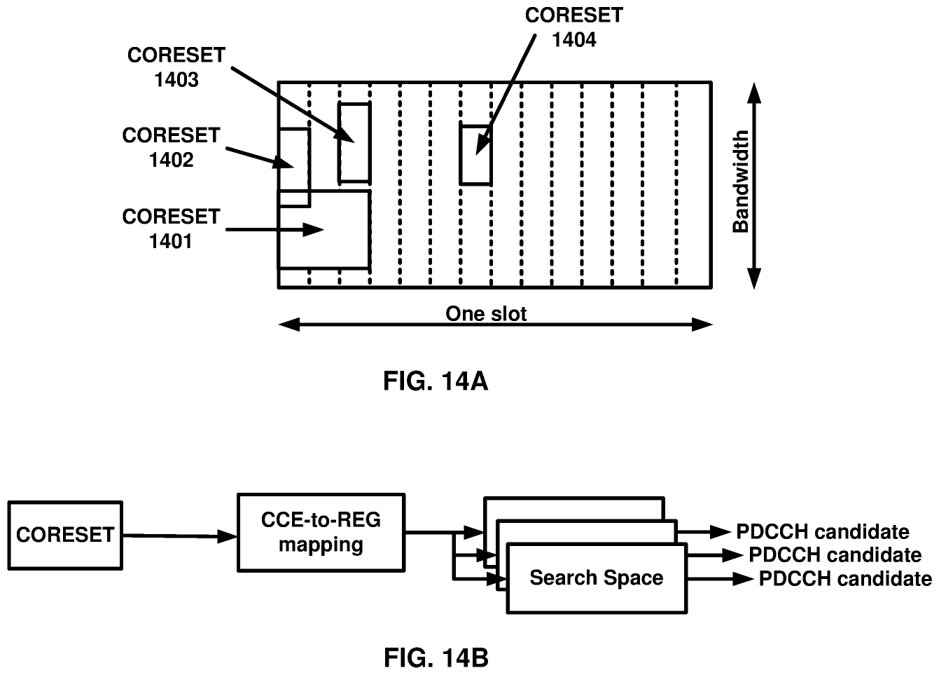

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

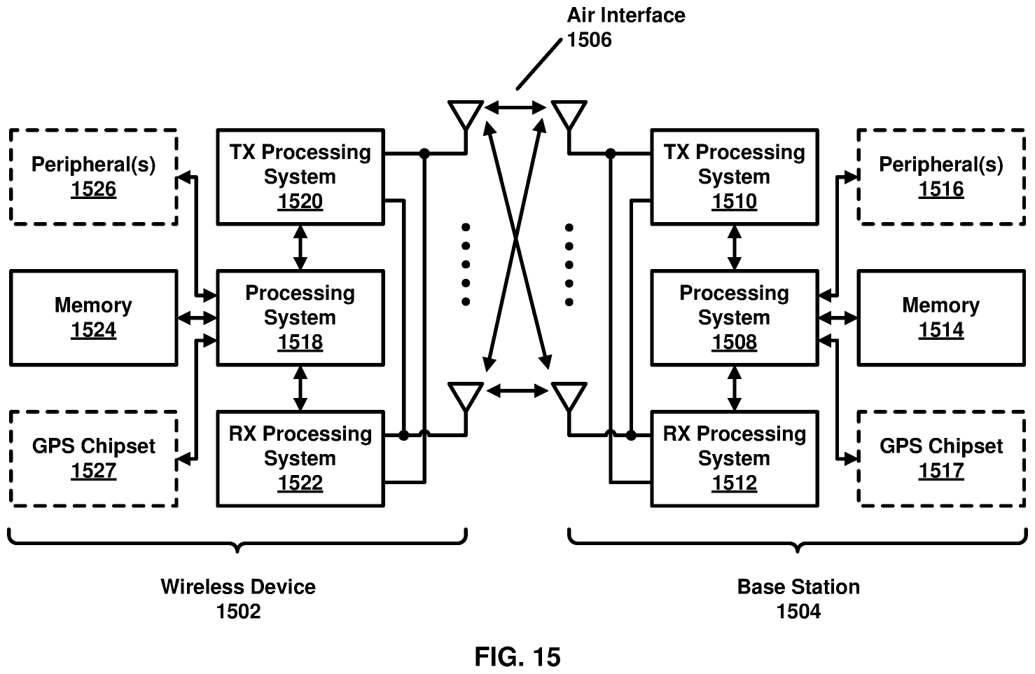

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

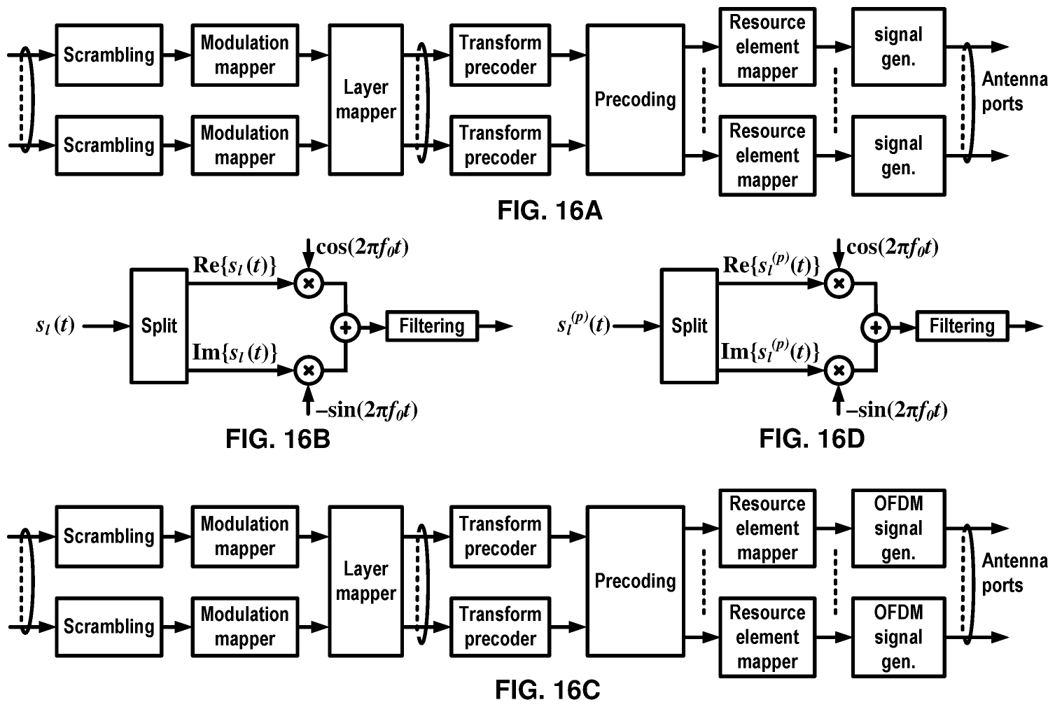

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, an CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual-connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

The hybrid-ARQ (hybrid automatic repeat request, HARQ) mechanism in the MAC layer targets very fast transmissions. A wireless device may provide feedback on success (e.g., an ACK) or failure (e.g., a NACK) of a downlink transmission (e.g., a PDSCH) to a base station for each scheduled/candidate transport block. A HARQ-ACK information bit value of 0 represents a negative acknowledgement (NACK) while a HARQ-ACK information bit value of 1 represents a positive acknowledgement (ACK).

It may be possible to attain a very low error rate probability of the HARQ feedback, which may come at a cost in transmission resources such as power. For example, a feedback error rate of 0.1-1% may be reasonable, which may result in a HARQ residual error rate of a similar order. This residual error rate may be sufficiently low in many cases. In some services requiring ultra-reliable delivery of data with low latency, e.g., URLLC, this residual error rate may not be tolerable. In such cases, the feedback error rate may be decreased and an increased cost in feedback signaling may be accepted, and/or additional retransmissions may be performed without relying on feedback signaling, which comes at a decreased spectral efficiency.

HARQ protocol may be a primary way of handling retransmissions in a wireless technology, e.g., NR. In case of an erroneously received packet, a retransmission may be required. Despite it not being possible to decode the packet, a received signal may still contain information, which may be lost by discarding the erroneously received packet. HARQ protocol with soft combining may address this shortcoming. In HARQ with soft combining, the wireless device may store the erroneously received packet in a buffer memory, and later combine the received packet with one or more retransmissions to obtain a single, combined packet/transport block that may be more reliable than its constituents. Decoding of the error-correction code operates on the combined signal. Retransmissions of codeblock groups that form a transport block may be handled by the physical layer and/or MAC layer.

The HARQ mechanism typically comprises multiple stop-and-wait protocols, each operating on a single transport block. In a stop-and-wait protocol, a transmitter stops and waits for an acknowledgment after each transmitted transport block. This protocol requires a single bit indicating positive or negative acknowledgment of the transport block; however, the throughput is low due to waiting after each transmission. Multiple stop-and-wait processes may operate in parallel, e.g., while waiting for acknowledgment from one HARQ process, the transmitter may transmit data of another HARQ process. The multiple parallel HARQ processes may form a HARQ entity, allowing continuous transmission of data. A wireless device may have one HARQ entity per carrier. A HARQ entity may support spatial multiplexing of more than four layers to a single device in the downlink, where two transport blocks may be transmitted in parallel on the same transport channel. The HARQ entity may have two sets of HARQ processes with independent HARQ acknowledgments.

A wireless technology may use an asynchronous HARQ protocol in the downlink and/or uplink, e.g., the HARQ process which the downlink and/or uplink transmission relates to, may be explicitly and/or implicitly signaled. For example, the downlink control information (DCI) scheduling a downlink transmission may signal the corresponding HARQ process. Asynchronous HARQ operation may allow dynamic TDD operation, and may be more efficient when operating in unlicensed spectra, where it may not be possible to guarantee that scheduled radio resources are available at the time for synchronous retransmissions.

Large transport block sizes may be segmented into multiple codeblocks prior to coding, each with its own CRC, in addition to an overall TB CRC. Errors may be detected on individual codeblocks based on their CRC, as well as on the overall TB. The base station may configure the wireless device with retransmissions based on groups of codeblocks, e.g., codeblock groups (CBGs). If per-CBG retransmission is configured, feedback is provided pre CBG. A TB may comprise of one or more CBGs. A CBG that a codeblock belongs to may be determined based on an initial transmission and may be fixed.

In the downlink, retransmissions may be scheduled in a same way as new data. For example, retransmissions may be scheduled at any time and any frequency location within a downlink cell and/or an active downlink BWP of a cell. A downlink scheduling assignment may contain necessary HARQ-related control signaling, e.g., HARQ process number; new-data indicator (NDI); CBG transmit indicator (CBGTI) and CBG flush indicator (CBGFI) in case per-CBG retransmission is configured; and/or information to schedule the transmission of the acknowledgment (ACK/NACK) in an uplink (e.g., a PUCCH), such as timing and resource indication information.

Upon receiving a downlink scheduling assignment in the DCI, the wireless device tries to decode the TB, e.g., after soft combining with previous attempts/receptions of the TB. Transmissions and retransmissions may be scheduled in a same framework. The wireless device may determine whether the transmission is a new transmission or a retransmission based on the NDI field in the DCI. An explicit NDI may be included for the scheduled TB as part of the scheduling information in the downlink. The NDI field may comprise one or more NDI bits per TB (and/or CBG). An NDI bit may be toggled for a new transmission, and not toggled for a retransmission. In case of a new transmission, the wireless device flushes soft buffer corresponding to the new transmission before receiving/storing the new transmission. In case of a retransmission, the wireless device may perform a soft combining of the received data with stored data in the soft buffer for the corresponding HARQ process based on the downlink scheduling assignment.

A time gap/interval/offset (e.g., K1) from a downlink data reception/resource to a transmission of a HARQ ACK/NACK corresponding to the downlink data may be fixed, e.g., multiple subframes/slots/symbols (e.g., three ms, 4 slots). This scheme with pre-defined timing instants for ACK/NACK may not blend well with dynamic TDD and/or unlicensed operation. A more flexible scheme, capable of dynamically controlling the ACK/NACK transmission timing may be adopted. For example, a DL scheduling DCI may comprise a PDSCH-to-HARQ_feedback timing field to control/indicate the transmission timing of an ACK/NACK corresponding to a data scheduled by the DL scheduling DCI in an uplink transmission (e.g., PUCCH). The PDSCH-to-HARQ_feedback timing field in the DCI may be used as an index of one or more indexes of K1 values in a pre-defined and/or RRC-configured table (e.g., a HARQ timing table). The K1 value may provide information of a gap/interval/offset between a second time to transmit the HARQ ACK/NACK relative to a first time of the reception of data (e.g., physical DL shared channel (PDSCH)).

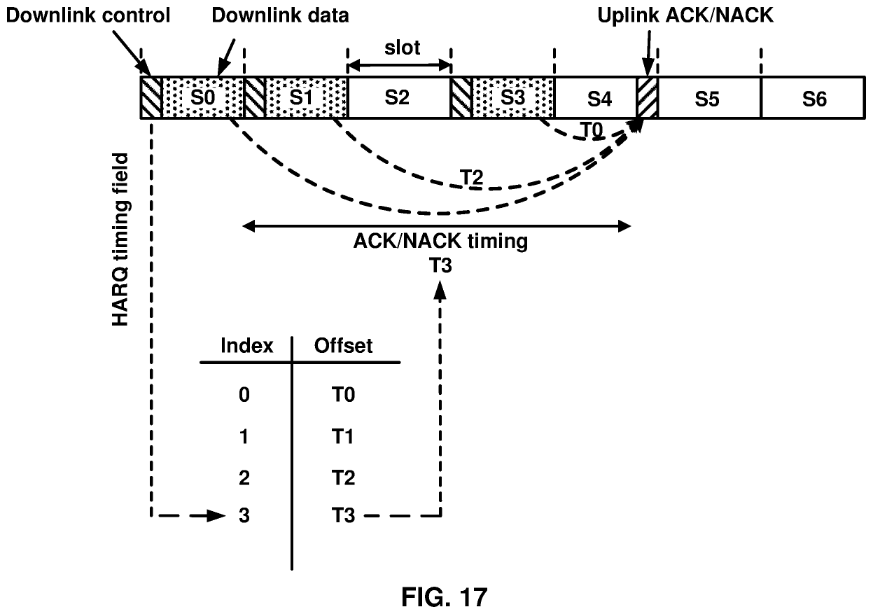

FIG. 17 illustrates an example of HARQ feedback timing determination, according to some embodiments. In this example, three DCIs are received in slots S0, S1, and S3 that schedule three downlink assignments in the same slots. In each downlink assignment, different HARQ feedback timing indices are indicated, e.g., in S0: 3, in S1: 2, and in S3: 0. The indicated indices (PDSCH-to-HARQ_feedback timing field) point to the HARQ timing table, e.g., for S0: T3 in indicated that points to S4 for transmission of the uplink ACK/NACK, for S1: T2 in indicated that points to S4 for transmission of the uplink ACK/NACK, for S3: TO in indicated that points to S4 for transmission of the uplink ACK/NACK. As a result, all three downlink assignments are acknowledged in the same slot, S4. The wireless device multiplexes the three acknowledgments and transmits the three acknowledgements in slot S4.

A wireless device may support a baseline processing time/capability. Some wireless devices may support additional aggressive/faster processing time/capability. A wireless device may report to a base station a processing capability, e.g., per sub-carrier spacing.

A wireless device may determine a resource for HARQ ACK/NACK transmission, e.g., frequency resource and/or PUCCH format and/or code domain, based on a location of a PDCCH (e.g., a starting control channel element (CCE) index) scheduling the transmission. The scheduling PDCCH/DCI may comprise a field, e.g., PUCCH resource indicator (PRI) field, that indicates a frequency resource for an uplink transmission of the HARQ ACK/NACK transmission. For example, the PRI field may be an index selecting one of a plurality of pre-defined and/or RRC-configured PUCCH resource sets.

A wireless device may multiplex a plurality of HARQ feedback bits that are scheduled for transmission in the uplink at a same time/slot, for example, in a carrier aggregation scenario and/or when per-CBG retransmission is configured. The wireless device may multiplex multiple ACK/NACK bits of multiple TBs and/or CBGs into one multi-bit HARQ feedback message/codebook. The multiple ACK/NACK bits may be multiplexed based on a semi-static codebook and/or a dynamic codebook. A base station, via RRC configuration, may configure either the semi-static codebook or the dynamic codebook for a cell configured with PUCCH resources (e.g., a primary cell, a PUCCH cell)

The semi-static codebook may be viewed as a matrix consisting of a time domain dimension and a component-carrier (and/or CBG and/or MIMO layer) dimension, both of which may be semi-statically configured and/or pre-defined. A size of the time domain dimension may be given by a maximum and/or a minimum HARQ ACK/NACK timing indicated in the pre-defined and/or RRC-configured table of HARQ ACK/NACK timings. A size of the component-carrier domain may be given by a number of simultaneous TBs and/or CBGs across all component carriers. A codebook size may be determined based on the time domain dimension and the component-carrier dimension for a semi-static codebook, regardless of actual scheduled transport blocks/PDSCHs. A number of bits to transmit in a HARQ feedback/report is determined based on one or more RRC configuration parameters. An appropriate format (e.g., PUCCH format) for uplink control signaling may be selected based on a codebook size (e.g., a number of HARQ ACK/NACK bits). Each entry of the matrix may represent a decoding outcome, e.g., positive (ACK) or negative (NACK) acknowledgments, of the corresponding transmission. One or more of the entries of the codebook matrix may not correspond to a downlink transmission opportunity (e.g., a PDSCH occasion), for which a NACK is reported. This may increase a codebook robustness, e.g., in case of missed downlink assignments, and the base station may schedule a retransmission of the missed TB/CBG. The size of the semi-static codebook may be very large.

The dynamic codebook may be used to address the issue with the potentially large size of the semi-static codebook. With the dynamic codebook, only the ACK/NACK information of scheduled assignments, including one or more semi-persistent scheduling, may be included in the report, e.g., not all carriers as in semi-static codebook. A size of the dynamic codebook may be dynamically varying, e.g., as a function of a number of scheduled carriers and/or as a function of a number of scheduled transport blocks. To maintain a same understanding of the dynamic codebook size, which is prone to error in the downlink control signaling, a downlink assignment index (DAI) may be included in the scheduling DCI. The DAI field may comprise a counter DAI (cDAI) and a total DAI (tDAI), e.g., in case of carrier aggregation. The counter DAI in the scheduling DCI indicates a number of scheduled downlink transmissions (PDSCH reception(s)/SPS PDSCH release(s)) up to the point the DCI was received, in a carrier first, PDCCH monitoring occasion index second manner. The total DAI in the scheduling DCI indicates a total number of scheduled downlink transmissions across all carriers up to the point the DCI was received. A highest cDAI at a current time is equal to the tDAI at this time.

The base station (BS) may configure a UE with enhanced dynamic codebook for HARQ feedback operation. The BS may trigger a group of DL transmissions, e.g., PDSCHs, for example, in an enhanced dynamic codebook operation. For example, one or more fields in a DCI may indicate one or more PDSCHs/PDCCHs to be acknowledged via an indicated UL resource. For example, the group of DL transmissions may comprise one or more HARQ processes, and/or may overlap with one or more slots/subframes, and/or may derived from a dynamic time window. The DCI may be carrying a DL scheduling assignment and/or an UL grant and/or a DCI may not be carrying a scheduling grant. The DCI may comprise one or more HARQ feedback timing values indicating the UL resource.

A DCI scheduling a DL assignment, e.g., PDSCH, may associate the PDSCH to a group. For example, the DCI may comprise a field indicating a group index. For example, a PDSCH scheduled by a first DCI format (e.g., DCI format 1_0) may be associated with a pre-defined group (e.g., PDSCH group #0). For example, an SPS PDSCH occasion may be associated with a pre-defined group. For example, and SPS PDSCH occasion may be associated with a first group, wherein the activation DCI indicates an index of the first group. For example, an SPS release PDCCH may be associated with a pre-defined group. For example, the SPS release PDCCH may indicate an index of a group.

The base station may schedule a first PDSCH with a PDSCH-to-HARQ-feedback timing, e.g., K1 value, in a channel occupancy time (COT) with a first group index. The PDSCH-to-HARQ-feedback timing may have a non-numerical/inapplicable value (NNK1). The BS may schedule one or more PDSCHs after the first PDSCH in the same COT, and may assign the first group index to the one or more PDSCHs. At least one of the one or more PDSCHs may be scheduled with a numerical K1 value.

The DCI may indicate a new ACK-feedback group indicator (NFI) for each PDSCH group. The NFI may operate as a toggle bit. For example, the UE may receive a DCI that indicates the NFI is toggled for a PDSCH group. The UE may discard one or more HARQ feedbacks for one or more PDSCHs in the PDSCH group. The one or more PDSCHs may be associated/scheduled with one or more non-numerical K1 values and/or numerical K1 values. The UE may expect DAI values of the PDSCH group to be reset.

A DCI (e.g., non-fallback DCI) scheduling a PDSCH may indicate a NFI for the scheduled group (e.g., based on the group index of the scheduled PDSCH). For example, T-DAI may be indicated in a (non-fallback) DCI scheduling PDSCH for the scheduled group if more than one DL cell is configured. For example, RRC message(s) may configure/indicate that the DCI may indicate NFI and/or T-DAI for a non-scheduled PDSCH group, e.g., with single or multiple configured DL cells.

A number of HARQ-ACK bits for one PDSCH group may change between successive requests for HARQ-ACK feedback for the same PDSCH group, e.g., in response to a NFI toggling (indicating a reset of the PDSCH grouping). HARQ-ACK feedback for (all) PDSCHs in a same PDSCH group may be carried/reported in a same PUCCH/PUSCH transmission. DAI (c-DAI and/or T-DAI) values may be accumulated within a PDSCH group. For example, DAI values (C-DAI and/or T-DAI) may be accumulated within a PDSCH group until NFI for the PDSCH group is toggled. The C-DAI and T-DAI for a PDSCH group may be reset when the NFI for the PDSCH group is toggled. C-DAI and T-DAI may not be reset by PUCCH transmission occasions. A UE may signal, e.g., as part of UE capability signaling, whether it supports the PDSCH grouping feature (enhanced dynamic codebook) or not.

The UE may be configured with enhanced dynamic codebook. The UE receive a first DCI format (e.g., DCI format 1_0) scheduling one or more PDSCHs. The one or more PDSCHs may be associated with a PDSCH group (e.g., a pre-defined PDSCH group, e.g., group #0). The first DCI format may not indicate an NFI value for the PDSCH group. The UE may determine the NFI value based on a second DCI format (e.g., DCI format 1_1) indicating the NFI value for the PDSCH group. The UE may detect the second DCI format since a last scheduled PUCCH and before a PUCCH occasion, wherein the second PUCCH occasion may comprise HARQ feedback corresponding to a PDSCH scheduled with the first DCI format. The last scheduled PUCCH may comprise HARQ feedback for the PDSCH group. The UE may not detect the second DCI that indicates the NFI value for the PDSCH group, and the UE may assume that the one or more PDSCHs scheduled by the first DCI format do not belong to any PDSCH group, and the UE may report the HARQ feedback of at least one PDSCH scheduled by the first DCI format since a last/latest PUCCH occasion.

A DCI may request/trigger HARQ feedback for one or more groups of PDSCHs, e.g., via a same PUCCH/PUSCH resource. HARQ feedbacks for multiple DL transmissions, e.g., PDSCHs, in a same group, may be transmitted/multiplexed in a same PUCCH/PUSCH resource. Counter DAI and total DAI values may be incremented/accumulated within a PDSCH group. In an example, the DCI may request/trigger HARQ feedback for more than one PDSCH group via a PUCCH.

The wireless device may generate a first sub-codebook comprising first HARQ-ACK information associated with a first PDSCH group index. The wireless device may generate the first HARQ-ACK information for a PUCCH transmission occasion in a slot. The first HARQ-ACK information may correspond (only) to detections of DCI formats each providing a same value of (scheduled) PDSCH group index (e.g., g) and/or NFI associated with the scheduled PDSCH group index (e.g., h(g)). The first HARQ-ACK information may correspond to detections of second DCI formats that do not provide a value of (scheduled) PDSCH group index (g) and/or NFI (h(g)). The second DCI formats may be associated with a same value of (scheduled) PDSCH group index (g) and/or NFI (h(g)). At least one of the DCI formats (first and second DCI formats) may provide a value of HARQ feedback timing indicator (k) that indicates the slot. At least one of the DCI formats may provide a value for NFI (h(g)).

The wireless device may generate a second sub-codebook comprising second HARQ-ACK information associated with a second PDSCH group index. The wireless device may generate the first HARQ-ACK information for a PUCCH transmission occasion in a slot. The second HARQ-ACK information may correspond to detections of DCI formats each providing a same value of (non-scheduled) PDSCH group index (e.g., (g+1)mod 2) and/or NFI associated with the PDSCH group index (e.g., h((g+1)mod 2). The second HARQ-ACK information may correspond to detections of second DCI formats that do not provide a value of PDSCH group index and/or NFI. The second DCI formats may be associated with a same value of PDSCH group index and/or NFI. At least one of the DCI formats may provide a value for NFI. The PUCCH transmission occasion may be a last one for multiplexing the second HARQ-ACK information and/or may not be after a PUCCH transmission occasion of the other PDSCH group.

In an example, if a value of a number of requested PDSCH group(s) field (e.g., q) in the (last) DCI format providing the value of PDSCH group index (g) is a first value (e.g., q=0), the UE may include (only) the first HARQ-ACK information for multiplexing in the PUCCH transmission occasion. In an example, if the value of the number of requested PDSCH group(s) field (e.g., q) in the (last) DCI format providing the value of PDSCH group index (g) is a second value (e.g., q=1), the UE may include the first HARQ-ACK information and the second HARQ-ACK information for multiplexing in the PUCCH transmission occasion. For example, if enhanced dynamic HARQ-ACK codebook is configured, a DCI (e.g., DCI format 1_1) may indicate a number of requested groups by one bit. For example, the number of requested groups in the DCI may indicate value “0” to request (only) the scheduled group, and value “1” to request both groups. The placement of HARQ-ACK feedback for the two (or more) PDSCH groups may be ordered based on increasing group index, e.g., when more than one PDSCH groups are reported in a HARQ-ACK feedback report via a PUCCH. For example, if the PDSCH group index (g) is a first value (e.g., g=1) indicating a first group index, the UE may append the first HARQ-ACK information to the second HARQ-ACK information for multiplexing in the PUCCH transmission occasion. For example, if the PDSCH group index (g) is a second value (e.g., g=0) indicating a second group index, the UE may append the second HARQ-ACK information to the first HARQ-ACK information for multiplexing in the PUCCH transmission occasion.

The generation of the first HARQ-ACK information and/or the second HARQ-ACK information may exclude the generation of HARQ-ACK information for SPS PDSCH reception(s). The UE may append the HARQ-ACK information corresponding to SPS PDSCH reception(s) (e.g., if any) after the first and the second HARQ-ACK information (sub-codebooks).

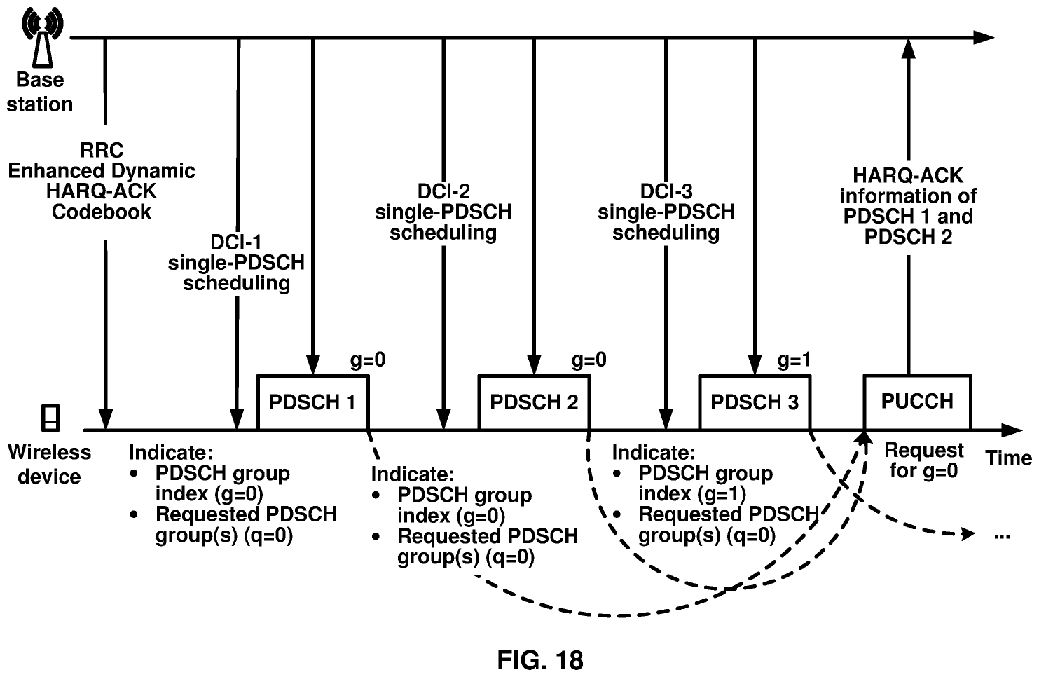

FIG. 18 illustrates an example of grouping PDSCHs using scheduling DCIs, according to some embodiments. As shown in FIG. 18, the wireless device may receive an RRC message indicating a first HARQ-ACK codebook for PDSCHs. For example, the RRC message may comprise a parameter (e.g., pdsch-HARQ-ACK-Codebook and/or pdsch-HARQ-ACK-Codebook-r16) indicating that the first HARQ-ACK codebook (e.g., enhanced dynamic codebook) is configured. The UE may receive a first DCI (DCI-1) scheduling a first PDSCH (PDSCH-1). The first DCI may comprise a field (e.g., PDSCH group index) indicating that the first PDSCH is associated with a first PDSCH group index (e.g., group index 0, g=0). The UE may receive a second DCI (DCI-2) scheduling a second PDSCH (PDSCH-2). The second DCI may comprise a field (e.g., PDSCH group index) indicating that the second PDSCH is associated with the first PDSCH group index (e.g., group index 0, g=0). The UE may receive a third DCI (DCI-3) scheduling a third PDSCH (PDSCH-3). The third DCI may comprise a field (e.g., PDSCH group index) indicating that the third PDSCH is associated with a second PDSCH group index (e.g., group index 1, g=1).

In example of FIG. 18, at least one of the three DCIs may indicate a slot for a PUCCH transmission comprising HARQ feedback information of one or more PDSCH groups. For example, the first DCI and/or the second DCI, that schedule PDSCHs associated with group 0, may comprise a second field (e.g., Number of requested PDSCH group(s), q). The second field may indicate whether HARQ feedback information of only the scheduled PDSCH group (e.g., group 0) or both PDSCH groups (e.g., g=0 and g=1) is requested in the indicated slot. For example, DCI-1 and/or DCI-2 may indicate q=0, indicating that the HARQ feedback of the scheduled group (group 0) is requested via the indicated PUCCH transmission. The UE may multiplex HARQ feedback information of PDSCH-1 and PDSCH-2 in the indicated PUCCH transmission occasion. The UE may determine not to multiplex HARQ feedback of PDSCH(s) associated with the other (non-scheduled) group (e.g., group 1) in the PUCCH transmission in the slot indicated by the scheduling DCI (DCI-1 and/or DCI-2). For example, the UE may not transmit the HARQ feedback of PDSCH-3, which is associated with group 1 (g=1), in the PUCCH transmission. For example, the third DCI may indicate a second slot for HARQ feedback transmission of the third PDSCH. For example, the third DCI may comprise a second field indicating whether HARQ feedback information of only the scheduled PDSCH group (e.g., group 1) or both PDSCH groups (e.g., g=0 and g=1) is requested in the second slot.

The UE may not expect to detect two or more DCI formats comprising/with HARQ feedback timing indicator values indicating a same slot and/or same PUCCH transmission occasion, such that the DCIs request/trigger HARQ feedback information of the scheduled group (e.g., indicate a number of requested PDSCH group(s) q=0), and the PDSCH group index field values indicated by the DCIs are different. The UE may receive the DCIs scheduling PDSCHs indicating a same slot and/or same PUCCH transmission occasion, such that the PDSCH group index field (g) and the number of requested PDSCH group(s) field (q) in the DCIs are consistent.

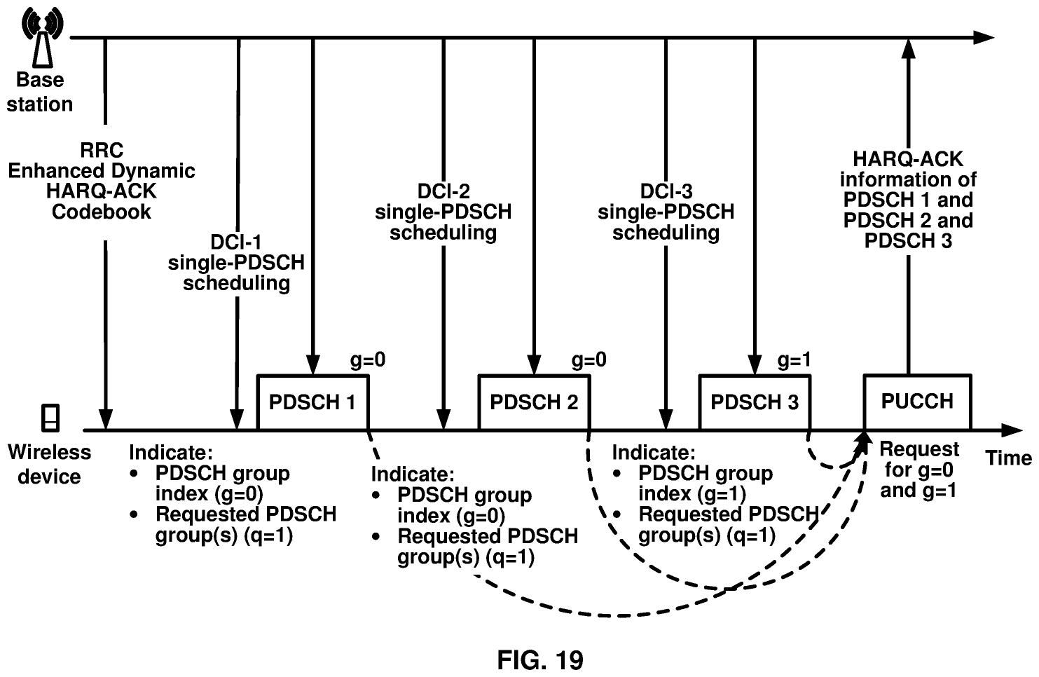

FIG. 19 illustrates an example of grouping PDSCHs using scheduling DCIs, according to some embodiments. As shown in FIG. 19, the wireless device may receive an RRC message indicating a first HARQ-ACK codebook for PDSCHs. For example, the RRC message may comprise a parameter (e.g., pdsch-HARQ-ACK-Codebook and/or pdsch-HARQ-ACK-Codebook-r16) indicating that the first HARQ-ACK codebook (e.g., enhanced dynamic codebook) is configured. The UE may receive a first DCI (DCI-1) scheduling a first PDSCH (PDSCH-1). The first DCI may comprise a field (e.g., PDSCH group index) indicating that the first PDSCH is associated with a first PDSCH group index (e.g., group index 0, g=0). The UE may receive a second DCI (DCI-2) scheduling a second PDSCH (PDSCH-2). The second DCI may comprise a field (e.g., PDSCH group index) indicating that the second PDSCH is associated with the first PDSCH group index (e.g., group index 0, g=0). The UE may receive a third DCI (DCI-3) scheduling a third PDSCH (PDSCH-3). The third DCI may comprise a field (e.g., PDSCH group index) indicating that the third PDSCH is associated with a second PDSCH group index (e.g., group index 1, g=1).

In example of FIG. 19, at least one of the three DCIs may indicate a slot for a PUCCH transmission comprising HARQ feedback information of one or more PDSCH groups. For example, the first DCI and/or the second DCI and/or the third DCI may comprise a second field (e.g., Number of requested PDSCH group(s), q). The second field may indicate whether HARQ feedback information of only the scheduled PDSCH group (e.g., group 0 or group 1) or both PDSCH groups (e.g., g=0 and g=1) is requested in the indicated slot. For example, DCI-1 and/or DCI-2 and/or DCI-3 may indicate q=1, indicating that the HARQ feedback of both PDSCH groups (group 0 and group 1) is requested via the indicated PUCCH transmission. The UE may multiplex HARQ feedback information of PDSCH-1 and PDSCH-2 and PDSCH-3 in the indicated PUCCH transmission occasion.

A UE may postpone transmission of HARQ-ACK information corresponding to PDSCH(s) in a PUCCH for K1 values that result in a time T, being the time between a last symbol of the PDSCH(s) and a starting symbol of the PUCCH, that is less than a required processing time for PUCCH transmission.

The UE may receive a downlink signal (e.g., RRC and/or DCI) scheduling a PDSCH. The UE may be configured with a (enhanced) dynamic codebook HARQ feedback operation. The PDSCH may be scheduled with a non-numerical value for PDSCH-to-HARQ-feedback timing, e.g., K1. For example, the downlink signal may indicate a non-numerical value for the PDSCH-to-HARQ-feedback timing of the PDSCH. The non-numerical value may indicate to the UE to postpone/defer the HARQ feedback of the corresponding PDSCH, e.g., until an uplink channel is indicated for transmitting the (pending) HARQ feedback. In response to receiving the non-numerical value, the UE may derive/determine a HARQ-ACK timing information (e.g., a slot) for the PDSCH by a next/later DCI. The next DCI may be a DL DCI scheduling one or more PDSCHs. The next DCI may comprise a numerical K1 value, indicating one or more slots comprising PUCCH/PUSCH resources for HARQ feedback transmission of one or more DL transmissions, comprising the PDSCH. The next DCI may trigger HARQ feedback transmission for one or more PDSCH groups comprising a group of the PDSCH. The UE may derive/determine the HARQ-ACK timing information for the PDSCH by a last/earlier DCI.

The UE may receive a first DCI scheduling a PDSCH with non-numerical K1 value. For (non-enhanced) dynamic HARQ-ACK codebook, the UE may determine/derive a HARQ-ACK timing for the PDSCH scheduled with non-numerical K1 value, based on a second DCI. The second DCI may schedule a second PDSCH with a numerical K1 value. The UE may receive the second DCI after the first DCI.

The base station may transmit a DCI requesting/triggering HARQ feedback of a HARQ-ACK codebook (e.g., Type-3 codebook or enhanced Type-3 codebook) containing all or a subset of DL HARQ processes (e.g., one-shot feedback request). The one-shot feedback request may be for all or a subset of component carriers configured for the UE. One-shot feedback may be configured separately from a HARQ-ACK codebook configuration.

The wireless device may transmit HARQ feedback of one or more PDSCHs in response to receiving a one-shot feedback request. A last/latest PDSCH for which an acknowledgment is reported in response to receiving the one-shot feedback request, may be determined as a last PDSCH within a UE processing time capability (e.g., baseline capability, N1). The UE may report HARQ-ACK feedback for one or more earlier PDSCHs scheduled with non-numerical K1 value. The one-shot feedback may be requested in a UE-specific DCI. The one-shot feedback may request HARQ feedbacks to be reported in a PUCCH. The HARQ feedback may be piggybacked on/multiplexed in a PUSCH.

The wireless device may be configured to monitor feedback request for one-shot HARQ-ACK codebook feedback. The feedback may be requested in a DCI format (e.g., DCI format 1_1). The DCI format may or may not schedule DL transmission (e.g., PDSCH). The DCI format may comprise a first field (e.g., a frequency domain resource allocation field) indicating a first value. The UE may determine that the DCI format does not schedule a PDSCH in response to the first field indicating the first value. The UE may ignore/discard one or more second fields of the DCI format (e.g., a HARQ process number and/or NDI field) in response to the determining. The UE may be scheduled to report one-shot feedback and one or more other HARQ-ACK feedbacks in a same slot/subframe/resource, and the UE may report only the one-shot feedback.

In a one-shot codebook, one or more NDI bits may follow one or more HARQ-ACK information bits for each of one or more TBs. The HARQ-ACK information bits and the corresponding NDI may be ordered in the one-shot codebook as follows: first in an increasing order of CBG index, second in an increasing order of TB index, third in an increasing order of HARQ process ID, and fourth in an increasing order of serving cell index.

The wireless device may transmit the HARQ-ACK for a PDSCH, that is scheduled with non-numerical K1 value, via one-shot HARQ feedback (e.g., Type-3 and/or enhanced Type-3) codebook. The wireless device may not include the HARQ-ACK for a PDSCH, that is scheduled with non-numerical K1 value, in a semi-static (e.g., Type-1) codebook. The wireless device may include the HARQ-ACK for a PDSCH, that is scheduled with non-numerical K1 value, in a semi-static codebook. With semi-static codebook, HARQ-ACK timing for a PDSCH scheduled with a non-numerical K1 may be derived based on the next DL DCI scheduling PDSCH with a numerical K1 value. A wireless device may report HARQ-ACK in the appended bit container. With dynamic (e.g., Type-2 and/or enhanced Type-2) codebook, HARQ-ACK timing for a PDSCH scheduled with DCI indicting a non-numerical K1 may be derived based on the next DCI scheduling PDSCH with a numerical K1 value. The wireless device may expect that DAI is reset for PDSCH transmitted later than N1 symbols before PUCCH transmission.

The achievable latency and reliability performance of a wireless technology (e.g., 5G NR) are keys to support use cases with tighter requirements such as Ultra-Reliable Low-Latency Communications. In order to extend the applicability of a wireless technology, certain enhancements may be needed in supporting use cases in entertainment industry, such as Augmented Reality (AR) and/or Virtual Reality (VR), and use cases with higher requirements such as factory automation, transport industry, electrical power distribution, and/or time-sensitive networks (TSN)/communications (TSC), as well as use cases such as controlled environments operating on unlicensed band where unexpected interference from other systems and/or radio access technology happens (e.g., only sporadically).

For example, additional/enhanced UE feedback (e.g., HARQ-ACK) can enable better HARQ operation and/or MCS selection for such use cases. Enhancements for UE HARQ-ACK feedback may comprise: avoiding unnecessary DL semi-persistent scheduling (SPS) HARQ-ACK dropping in time division duplex (TDD) system; SPS HARQ-ACK payload size reduction and/or skipping; SPS HARQ-ACK skipping for skipped SPS PDSCHs; Type-1 (e.g., semi-static) HARQ-ACK codebook for sub-slot PUCCH; ‘Sub-slot’ type of PUCCH repetition; and/or retransmission of canceled and/or dropped HARQ-ACK (e.g., low-priority HARQ-ACK).

In an example, (e.g., in NR Rel-15 and Rel-16), all the SPS PDSCH of a specific SPS configuration may have a fixed PDSCH-to-HARQ timing indicator value (K1) as defined in the activation DCI. With the introduction of shorter (e.g., down to 1 slot) SPS periodicities in Rel-16, a significant percentage of the SPS HARQ-ACK feedback may be dropped in a TDD system, e.g., if the corresponding PUCCH resource collides with at least one DL or flexible symbol. When the SPS periodicity is down to 1 slot, the collision between SPS HARQ-ACK and semi-static DL configuration as well as dynamic slot format indication (SFI) would happen frequently especially for DL heavy TDD frame structure. Frequent HARQ-ACK dropping in TDD may make a negative impact on performance because of potential unnecessary re-transmissions. Dropping the HARQ-ACK too frequently may result in low resource efficiency due to resulting unnecessary re-transmission(s), and/or may have impact on URLLC latency, and accordingly, should be avoided. It may be necessary/beneficial to avoid dropping HARQ-ACK in URLLC applications, especially when the probability is large.

Enhancements may be considered to avoid SPS HARQ-ACK dropping for TDD due to PUCCH collision with at least one invalid (e.g., DL or flexible) symbol. For example, the enhancements may allow the SPS HARQ-ACK to be transmitted in a later PUCCH (e.g., deferring/postponing). Methods for SPS HARQ-ACK enhancement may comprise: deferring SPS HARQ-ACK until the first available valid PUCCH resource; gNB dynamic indication of one or more transmission opportunities for the postponed/deferred HARQ-ACK to UE; indicating HARQ-feedback timing value (K1 value) for each SPS transmission in a time window configured by RRC; supporting one-shot HARQ-ACK request (i.e. Type 3 codebook) for group of SPS HARQ processes; supporting non-numerical (i.e. NNK1) for DL SPS operation in licensed spectrum; new HARQ-ACK feedback timing mechanism; HARQ-ACK feedback codebook for all available SPS PDSCHs (e.g., including payload size optimizations); UE to select a first applicable K1 value from a set of configured K1 values to allow HARQ-ACK load balancing; autonomous HARQ-ACK resending and/or multiplexing the dropped HARQ-ACK information to the different HARQ-ACK information; etc. For example, in case of collision with invalid symbol(s) for UL transmission (e.g., semi-static DL or flexible symbol(s)), HARQ-ACK postponing for DL SPS may be considered.

In an example, the UE may not be able to transmit a HARQ-ACK, e.g., due to collision with other UL transmissions (inter-UE cancelation and/or intra-UE prioritization). Uplink transmissions may be associated with different PHY priorities, e.g., based on the respective services/applications. For example, the UE may be scheduled with a low-priority HARQ-ACK transmission (e.g., corresponding to enhanced mobile broadband-eMBB) and a second high-priority UL transmission (e.g., PUSCH, PUCCH, SR, etc., corresponding to URLLC) at the same time. The UE may drop/cancel the low-priority HARQ-ACK transmission. For example, low priority HARQ-ACK transmission may be dropped/canceled due to overlapping high-priority UL channels (for intra-UE prioritization) or due to UL cancelation indication using DCI format 24 (for HARQ-ACK carried on PUSCH). Dropping/canceling low priority HARQ-ACK may have negative impact on some services/applications (e.g., eMBB performance). There may be a need for enabling re-transmissions of dropped low-priority HARQ-ACK.

For example, for many UEs, DL and UL traffic may be relatively symmetric, so it may be highly likely that HARQ-ACK is multiplexed on PUSCH especially for DL heavy TDD frame structure. In this case, low-priority HARQ-ACK dropping due to inter-UE cancelation may happen frequently, which results in lots of unnecessary PDSCH retransmissions and decrease system spectral efficiency.

In an example, multiplexing HARQ-ACK of different priorities on a single PUCCH may be supported. In an example, if multiplexing timing is not satisfied, low-priority HARQ-ACK may be dropped. In an example, to protect the high-priority channels, dropping low-priority HARQ-ACK may be better compared to multiplexing (e.g., due to timeline, payload size of low-priority HARQ-ACK etc.). In an example, low-priority HARQ-ACK may not be multiplexed on a high priority channel, and the low-priority HARQ-ACK may be dropped. Retransmission of cancelled/dropped low-priority HARQ-ACK may be used. In another example, the low-priority HARQ-ACK may be multiplexed with high-priority channels.

HARQ-ACK may not be transmitted in a scheduled/indicated resource (may be dropped/cancelled) due to Intra/lnter-UE prioritization and/or TDD collision with DL/SSB symbols. HARQ-ACK retransmission may be a general HARQ-ACK transmission enhancement to solve HARQ-ACK dropping/cancellation issue due to one or more reasons, e.g., PUCCH dropping due to collision with DL symbols/SSB, and/or low-priority HARQ-ACK dropping, and/or UL cancelation, and/or HARQ-ACK compression due to reliability requirement when multiplexing.

Enhancements may be considered to enable re-transmission of cancelled HARQ-ACK. Methods for HARQ-ACK retransmission may comprise: gNB indicating a new PUCCH resource for ‘re-transmission’; enhanced dynamic (Type-2) codebook (i.e., PDSCH grouping); one-shot (Type-3) codebook; and/or non-numerical HARQ-feedback timing value (NNK1). In an example, a gNB may schedule PUSCH without UL-SCH (e.g., if A-CSI is triggered). A PUSCH without UL-SCH/A-CSI and with only HARQ-ACK may be scheduled to enable HARQ-ACK retransmission.

The wireless device may defer a HARQ-ACK, e.g., a dropped HARQ-ACK of a SPS PDSCH reception/release, and/or a cancelled low-priority HARQ-ACK, until a first available valid UL slot or UL symbols. The deferred HARQ-ACK may be pending for transmission until an uplink resource is indicated/determined. The deferral may or may not be limited to a maximum configured k1 (HARQ-ACK timing value) of the K1 set. The deferral may or may not be limited to a certain/configured maximum duration (e.g., delaying value). The deferral may correspond to a k1 value of the configured K1 set.

The wireless device may defer/postpone a HARQ-ACK transmission if the corresponding (initial) PUCCH resource overlaps with semi-static DL and/or semi-static flexible symbols (e.g., indicated by TDD configuration in RRC message). In an example, the number of bits that the UE may defer is limited (e.g., pre-defined and/or configured by RRC). The wireless device may defer the HARQ-ACK (e.g., SPS HARQ-ACK or low-priority HARQ-ACK) if there is not any available (e.g., UL and/or flexible) symbols in an indicated slot/sub-slot for PUCCH transmission comprising the HARQ-ACK. In an example, the deferral may comprise a codebook only including SPS HARQ-ACK. In an example, the UE may defer a HARQ-ACK if the initial/original PUCCH resource, determined based on the HARQ-feedback timing value and/or the PUCCH resource indicator and/or PUCCH configuration (e.g., SPS-PUCCH-AN-List-r16), is not valid.

A PUCCH resource may not be valid if it overlaps with at least one DL symbol and/or SSB. The UE may determine a symbol direction (e.g., DL or UL or flexible) based on semi-static TDD configuration (e.g., TDD-UL-DL-ConfigCommon and/or TDD-UL-DL-ConfigDedicated). The UE may determine a symbol direction (e.g., DL or UL or flexible) based on s DCI indicating slot format indication (SFI). A PUCCH resource may not be valid if it overlaps with at least one DL symbol and/or flexible symbol. The DL/flexible symbol may be semi-static DL/flexible (e.g., based on TDD configuration) and/or dynamic DL/flexible (e.g., based on SFI). In an example, the HARQ-ACK deferral may be for any PUCCH dropping case, e.g., in response to overlapping DL/SSB/flexible symbol and/or in response to collision with high-priority uplink transmission, and/or in response to receiving an uplink cancellation indication from the base station. In an example, for a given UL slot, the untransmitted HARQ-ACKs (e.g., of the SPS PDSCHs) before the DL slot corresponding to the indicated K1 may be deferred to the given UL slot. In an example, a maximum of N HARQ-ACK bits may be deferred. In an example, a subset of SPS PDSCH configurations may be configured for deferral, e.g., to limit the codebook size. In an example, a HARQ-ACK may be deferred up to N times (e.g., N>=1). N may be pre-defined and/or configured by the base station.

The wireless device may defer a HARQ-ACK, e.g., a dropped SPS HARQ-ACK and/or a cancelled low-priority HARQ-ACK, until a first/next available PUCCH. An available PUCCH may be a valid PUCCH, e.g., not overlapping with any semi-static DL symbol and/or semi-static flexible symbol and/or dynamic DL/flexible symbol and/or SSB. For example, an invalid PUCCH resource may overlap with at least one semi-static DL symbol and/or semi-static flexible symbol and/or dynamic DL/flexible symbol and/or SSB. For example, a valid PUCCH resource may overlap with UL symbols and/or flexible symbols. For SPS HARQ-ACK deferral, for the determination of valid symbols in the initial slot/sub-slot a collision with semi-static DL symbols, SSB and CORESET #0 may be regarded as ‘invalid’ or ‘no symbols for UL transmission’.

The wireless device may determine the next/first available/valid PUCCH resource for transmitting a pending/deferred/postponed/cancelled HARQ-ACK. The determination may be based on the initial (target) PUCCH resource, e.g., before multiplexing the deferred/pending HARQ-ACK. The UE may determine the next/first available PUCCH resource using/based on semi-static PUCCH configurations (e.g., SPS-PUCCH-AN-List-r16 or n1PUCCH-AN resources). In an example, UE may receive an RRC message indicating that SPS HARQ-ACK deferral is configured. The SPS HARQ-ACK deferral may be per SPS configuration. The SPS HARQ-ACK deferral may be per PUCCH cell group. For example, any SPS HARQ-ACK within a PUCCH ell group may be subject to deferral.

In an example, the UE may defer a HARQ-ACK (e.g., SPS HARQ-ACK), if the HARQ-ACK in the initial slot/sub-slot cannot be transmitted as the resulting PUCCH resource for transmission (e.g., using the PUCCH by SPS-PUCCH-AN-List-r16 or n1PUCCH-AN) is not valid. For example, if SPS HARQ-ACK is multiplexed with dynamic PUCCH resource (e.g., based on PUCCH-ResourceSet) then it may not be deferred. In an example, the UE may defer a HARQ-ACK (e.g., SPS HARQ-ACK), if the PUCCH resource (e.g., configured by SPS-PUCCH-AN-List-r16 or n1PUCCH-AN) for the HARQ-ACK transmission assuming SPS HARQ-ACK only is not valid in the initial slot/sub-slot. For example, the UE may defer SPS HARQ even if multiplexing and transmission in initial slot (e.g., based on PRI) would be possible. For example, deferral decision may be done before the multiplexing decision. In an example, the UE may defer a HARQ-ACK (e.g., SPS HARQ-ACK), if the HARQ-ACK in the initial slot/sub-slot cannot be transmitted as the resulting PUCCH resource for transmission (e.g., using SPS-PUCCH-AN-List-r16, n1PUCCH-AN or other configured PUCCH resource(s)) is not valid. In an example, the UE may defer a HARQ-ACK (e.g., SPS HARQ-ACK), if there is no available symbol for an UL transmission in the initial slot/sub-slot. In an example, the UE may defer a HARQ-ACK (e.g., SPS HARQ-ACK), if there is no available symbol for an UL transmission in the initial slot/sub-slot including additionally configured with invalid symbols/slots for SPS HARQ-ACK.

The target (next/first available) PUCCH resource may be associated with the same SPS configuration as the initial (delayed) PUCCH resource. The UE may determine the next/first available PUCCH resource using/based on semi-statically scheduled PUCCH resources (e.g., sps-PUCCH-AN-List-r16, and/or multi-CSI-PUCCH-ResourceList) and/or dynamically scheduled PUCCH resources (e.g., PUCCH-ResourceSet). The UE may determine the next/first available PUCCH resource using/based on additional/separate PUCCH resources configured for deferral. The deferral may comprise separate k1 set (HARQ-ACK timing values).

The UE may determine the next/first available/valid PUCCH resource for transmitting a pending/deferred/postponed/cancelled/dropped HARQ-ACK. The next available PUCCH may be the earlier of semi-statically configured PUCCH resource (e.g., configured by RRC parameter(s) sps-PUCCH-AN-List-r16 or n1PUCCH-AN), and/or a dynamically indicated PUCCH resource (configured by RRC parameter(s) PUCCH-ResourceSet). The next available PUCCH may be associated with/based on the first available slot defined by PUCCH of sps-PUCCH-AN-List-r16 or n1PUCCH-AN. For example, SPS HARQ PUCCH resource may be determined based on the total number of SPS HARQ-ACK associated with the slot. For example, only a deferred payload may be used to determine the target slot (before any multiplexing). For example, validity of the target slot may be determined by initial SPS PUCCH resource. For example, the next available PUCCH may be next SPS PUCCH occasion of the (same) SPS configuration.

The UE may select/determine the next/target PUCCH resource based on the size of the HARQ-ACK codebook, e.g., the deferred HARQ-ACK codebook and/or the HARQ-ACK codebook in the target slot before/after multiplexing the deferred HARQ-ACK. For example, the size of the HARQ-ACK codebook may be below a pre-defined/pre-configured threshold. The number of (target) PUCCH symbols may not be below a threshold, e.g., not less than the number of symbols of the original PUCCH. In an example, the selected/target PUCCH resource may be the one with the earliest ending symbol.

The UE may multiplex a deferred/pending HARQ-ACK with semi-static and/or dynamic HARQ-ACK (e.g., triggered by a DCI) in the target/determined PUCCH. In an example, the base station may configure whether the UE may multiplex the deferred/pending HARQ-ACK with semi-static and/or dynamic HARQ-ACK (e.g., triggered by a DCI) in the target/determined PUCCH. The UE may append the deferred/pending HARQ-ACK bits to the HARQ-ACK codebook in the target/determined PUCCH. The HARQ-ACK codebook may be based on Type-1 and/or (enhanced) Type-2 (dynamic) and/or (enhanced) Type-3 (one-shot) codebook. UE may apply/use UCI multiplexing and/or PUCCH overriding rules for deferred HARQ-ACK in the target slot, if applicable.

SPS HARQ-ACK may be deferred from the initial slot/sub-slot, determined by k1 in the activation DCI, to the target slot/sub-slot, determined by k1+k1def. The UE may check the validity of a target slot/sub-slot evaluating from one slot/sub-slot to the next sub/sub-slot (i.e., in principle k1def granularity is 1 slot/sub-slot). For example, the UE may check/evaluate every slot/sub-slot following the initial/original slot/sub-slot (determined based on k1) until a valid PUCCH resource is determined in a target slot.

The base station may use dynamic indication/triggering for the postponed/deferred/cancelled/dropped HARQ-ACK to UE. For example, the base station may indicate a single transmission opportunity. For example, an enhanced Type-2 (dynamic) codebook may be configured that enables grouping HARQ-ACKs and triggering group(s) of HARQ-ACK transmission. For example, the wireless device may assume that a postponed/deferred/cancelled/dropped HARQ-ACK is associated with a non-numerical/inapplicable HARQ-ACK timing value (NNK1), e.g., may wait for a second DCI to indicate a resource for the postponed/deferred/cancelled/dropped HARQ-ACK transmission. The postponed/deferred/cancelled HARQ-ACK may be SPS HARQ-ACK deferred due to collision with DL/SSB symbol(s), and/or low-priority (e.g., eMBB) HARQ-ACK deferral due to collision with high-priority uplink transmission and/or cancelled HARQ-ACK due to uplink cancellation indication received from the base station. For example, the base station may use a Type-3 codebook (e.g., one-shot/enhanced one-shot HARQ feedback) request to trigger transmission of all and/or a subset of HARQ ACKs, e.g., comprising the postponed/deferred/cancelled HARQ-ACKs. For example, the base station may configure additional/independent PUCCH resources for postponed/deferred/cancelled HARQ-ACK transmission.

In an example, the base station may transmit a DCI to trigger a pending/deferred/postponed/cancelled/dropped HARQ-ACK transmission. For example, the UE may receive a DCI comprising an UL grant scheduling a PUSCH to carry dropped/pending/deferred/cancelled HARQ-ACK(s). For example, a DCI may schedule new PUCCH/PUSCH resource for low-priority HARQ-ACK re-transmission.

In an example, the UE may receive a PDSCH of a certain HARQ Process ID. The UE may drop/cancel the deferred SPS HARQ bit(s) for this HARQ Process ID. In an example, for SPS HARQ-ACK deferral, the initial HARQ-ACK transmission occasion may be considered to determine the out-of-order HARQ condition.

The existing technology defines frequency ranges for wireless operation. For example, NR Rel-15 and Rel-16 define two frequency ranges (FRs): FR1 spanning from 410 MHz to 7.125 GHz and FR2 spanning from 24.25 GHz to 52.6 GHz. Recent studies reveal a global availability of bands beyond the currently operational frequency ranges, e.g., in the 52.6 GHz to 71 GHz range. The proximity of the higher frequency range to FR2 and the imminent commercial opportunities for high data rate communication makes it compelling for wireless technologies to address operation (e.g., NR operation) in this frequency regime. For example, 3GPP has decided to extend FR2 operation up to 71 GHz, considering both licensed and unlicensed operation, with the adoption of one or more new numerologies (e.g., larger subcarrier spacings). These high frequency bands comprise unlicensed bands (e.g., unlicensed 60 GHz band). Existing procedures (e.g., LAA/NR-U defined procedures) for operation in unlicensed spectrum may be leveraged towards operation in these high frequency unlicensed bands. For channel access, both LBT mode and no-LBT mode may be supported to cover a wide range of use cases and regulatory requirements.

Supporting larger subcarrier spacings (e.g., 120 KHz, 240 KHz, 480 KHz, and 960 KHz) may require enhancements of some existing processing timelines; e.g., processing capability for PUSCH scheduled by RAR UL grant; dynamic SFI and SPS/CG cancellation timing; timeline for HARQ-ACK information in response to a SPS PDSCH release/dormancy; minimum time gap for wake-up and SCell dormancy indication; BWP switch delay; multi-beam operation timing (timeDurationForQCL, beamSwitchTiming, beam switch gap, beamReportTiming, etc.); timeline for multiplexing multiple UCI types; minimum of P_switch for search space set group switching; appropriate configuration(s) of scheduling time offsets such as k0 (for PDSCH), k1 (for HARQ), k2 (for PUSCH); PDSCH processing time (N1), PUSCH preparation time (N2), HARQ-ACK multiplexing timeline (N3); CSI processing time, Z1, Z2, and Z3, and CSI processing units; potential enhancements to CPU occupation calculation; related UE capability(ies) for processing timelines; minimum guard period between two SRS resources of an SRS resource set for antenna switching.

Due to higher processing requirements in these high frequency bands and much shorter slot durations, limitations to PDCCH monitoring may be considered. For example, increased minimum PDCCH monitoring unit may be supported to help with UE processing. Time domain scheduling enhancements for PDSCH/PUSCH may be supported, e.g., increasing minimum time-domain scheduling unit to be larger than one symbol, multi-PDSCH scheduled by one DCI (multi-TTI scheduling), mapping one TB to multiple slots (e.g., TTI bundling), etc. Scheduling each PUSCH and/or PDSCH via a separate DCI may waste resources, because many of the signaled parameters may be redundant across the respective DCIs. For example, multiple PDSCH/PUSCH (PxSCH) scheduling with a single DCI (using existing DCI formats or new DCI format(s)) may be supported to reduce scheduling overhead as well as PDCCH monitoring requirements in time domain.

For a wireless device and a serving cell, scheduling multiple PDSCHs by a single DL DCI and scheduling multiple PUSCHs by a single UL DCI may be supported. Each PDSCH/PUSCH may have individual/separate TB(s). Each PDSCH/PUSCH may be confined within a slot. A maximum number of M PDSCHs or PUSCHs may be scheduled with a single DCI (e.g., M=8 or 16 or 32). For multi-PUSCH/PDSCH scheduling, a TDRA table may be configured such that each row indicates up to X multiple PUSCHs/PDSCHs, which may be continuous and/or non-continuous in time domain. Each PUSCH/PDSCH may have a separate SLIV and mapping type. A number of the scheduled PUSCHs/PDSCHs (X) may be signaled by a number of indicated valid SLIVs in the row of the TDRA table signaled in the DCI. The TDRA table may be configured such that each row indicates up to X (e.g. 8) PUSCH/PDSCH groups. The PUSCH/PDSCH groups may be non-continuous. Each PUSCH/PDSCH group may have a separate SLIV, mapping type, and/or number of slots or PUSCHs/PDSCHs (N). Within each group, N PUSCHs/PDSHCs may occupy the same OFDM symbols indicated by the SLIV and mapping type. A number of scheduled PUSCHs/PDSCHs may be the sum of number of PUSCHs/PDSCHs in all PUSCH/PDSCH groups in the row of the TDRA table signaled in DCI (e.g., 1 to M).

For multi-PUSCH/PDSCH scheduling, CBG (re)transmission may or may not be supported. Ultra Reliable Low Latency Communications (URLLC) related fields such as priority indicator and/or open-loop power control parameter set may be indicated in the DCI for multiple scheduled PUSCHs/PDSCHs. For multiple PUSCHs/PDSCHs scheduled by a single DCI, NDI and/or RV may be signaled per PUSCH/PDSCH. A number of NDI bits and/or RV bits in the DCI may be determined based on the configured TDRA table. HARQ process ID signaled in the DCI may apply to a first scheduled PUSCH/PDSCH of the multiple PUSCHs/PDSCHs scheduled by the DCI. HARQ process ID may be incremented by 1 for subsequent PUSCHs/PDSCHs in the scheduled order (with modulo operation as needed). Same FDRA and/or MCS value indicated by the DCI may be applied to all scheduled PUSCHs/PDSCHs.

For a DCI scheduling multiple PDSCHs, a slot offset k0 (indicated by the TDRA field in the DCI) may indicate a gap between a slot of the scheduling DCI (e.g., the PDCCH reception slot) and a first slot of the multiple slots of PDSCHs scheduled by the DCI. For example, k0 may indicate the slot offset between the DCI and an earliest PDSCH scheduled by the DCI.

For multi-PDSCH scheduling, multiple HARQ-ACKs corresponding to the multi-PDSCHs may be fed back. For a DCI scheduling multiple PDSCHs, HARQ-ACK information corresponding to PDSCHs scheduled by the DCI may be multiplexed in a single PUCCH in a first slot. The first slot may be determined based on a first offset, K1. The first offset may be indicated by the DCI, e.g., by a PDSCH-to-HARQ_feedback timing indicator field in the DCI. The first offset may be indicated by RRC signaling, e.g., provided by dl-DataToUL-ACK if the PDSCH-to-HARQ_feedback timing indicator field is not present in the DCI. The first offset (K1) may indicate a slot offset between a slot of a last PDSCH scheduled by the DCI and a slot carrying the HARQ-ACK information corresponding to the scheduled PDSCHs.

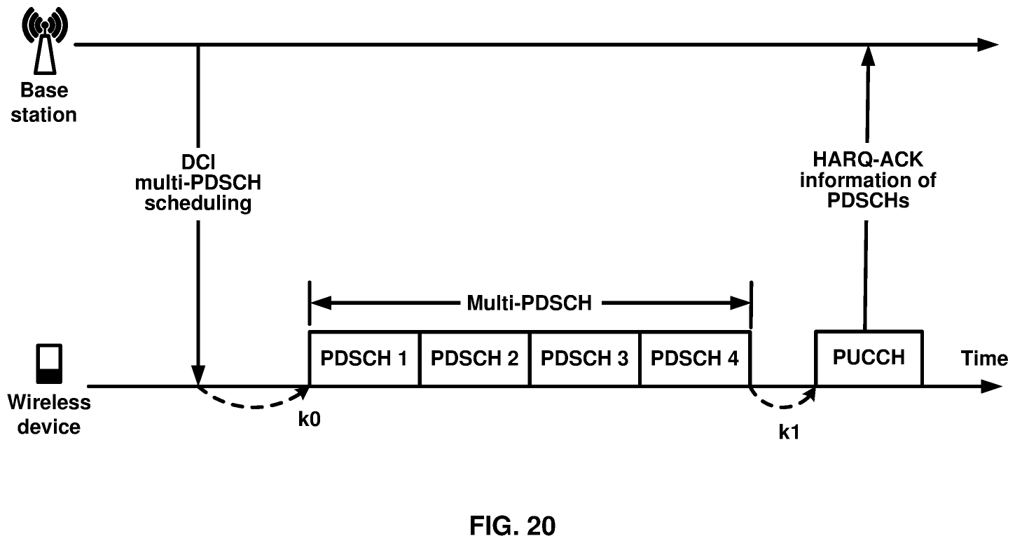

FIG. 20 illustrates an example of HARQ-ACK transmission associated with a DCI scheduling multiple PDSCHs, according to some embodiments. As shown in the figure, the DCI indicates a k0 slot offset and a k1 slot offset. The wireless device determines a first slot associated with a first PDSCH of the multiple scheduled PDSCHs (PDSCH 1) by applying the k0 slot offset to a slot where the DCI is received. The wireless device determines a number of scheduled PDSCHs based on the DCI, e.g., the TDRA field in the DCI. In this figure, the wireless device determines four PDSCHs scheduled by the DCI. The multiple PDSCHs may be scheduled in one or more slots starting from the first slot indicated by the k0 slot offset. The multiple PDSCHs may be in consecutive slots. The multiple PDSCHs may be continuous and/or discontinuous, e.g., a non-zero gap may or may not be between adjacent PDSCHs scheduled by the DCI. A gap may comprise zero or more symbols and/or slots. The wireless device may determine a second slot for HARQ-ACK transmission of the multiple PDSCHs via a PUCCH based on the k1 slot offset. The wireless device may apply the k1 slot offset to a slot of the last scheduled PDSCH (PDSCH 4) to determine the second slot. The wireless device may transmit HARQ-ACK information associated with all the scheduled PDSCHs via the PUCCH resource in the second slot.

A PDSCH processing time may be considered, e.g., a first symbol of the PUCCH comprising the HARQ-ACK information of PDSCHs scheduled by the DCI, may not start earlier than a time gap after a last symbol of a PDSCH reception associated with the HARQ-ACK information (e.g., the last PDSCH). The time gap may be given by the UE PDSCH processing capability in the corresponding frequency band.

In an example, a scheduler (e.g., base station) may be prohibited to indicate a HARQ feedback timing earlier than a PDSCH processing time for a last PDSCH of the multi-PDSCH scheduled by a single DCI. However, flexibility of HARQ feedback scheduling may be degraded. Moreover, an impact on HARQ feedback latency especially for the earliest scheduled PDSCHs may be problematic, e.g., for URLLC traffic.

In an example, HARQ-ACK information corresponding to different PDSCHs scheduled by a single DCI may be carried by different PUCCH(s), e.g., in different slots. In an example, the DCI may indicate HARQ-ACK timing earlier than the PDSCH processing time for the last PDSCH(s). In an example, the wireless device may postpone HARQ feedback of one or more of the multiple PDSCHs scheduled by a DCI. The base station may trigger feedback of the postponed HARQ-ACKs later, e.g., using a second DCI (as in non-numerical K1 indication).

In existing technologies, a wireless device may receive a DCI that may schedule a single transport block reception via a first downlink channel (e.g., PDSCH). The DCI may indicate a single slot comprising an uplink resource (e.g., PUCCH resource) for transmitting the feedback information (e.g., HARQ-ACK) of the transport block associated with the first downlink channel. For example, the DCI may trigger one PUCCH transmission comprising the feedback information. The wireless device may have one or more pending (e.g., deferred/postponed/cancelled/dropped) feedback information (e.g., HARQ-ACK), of one or more second downlink channels (e.g., received before the first PDSCH). The pending feedback information may correspond to a postponed HARQ-ACK associated with a non-numerical/inapplicable feedback timing value (NNK1). The pending feedback information may correspond to a low-priority HARQ-ACK that is dropped in response to collision with a high-priority uplink transmission (intra-UE prioritization). The pending feedback information may correspond to a HARQ-ACK (e.g., associated with DL SPS) that is deferred in response to overlap with DL symbols and/or SSB and/or CORESET #0. The pending feedback information may correspond to a HARQ-ACK transmitted on an uplink channel that is cancelled in response to an UL cancellation indication from the base station (inter-UE prioritization). The wireless device may wait for a trigger/indication/request from the base station to (re)transmit the pending feedback information.

In the existing technologies, the wireless device may (re)transmit the pending feedback information in a slot indicated by a (next) DCI comprising a numerical/applicable feedback timing value. The wireless device may determine an UL resource (e.g., a PUCCH resource) in the slot indicated by the DCI. So, the base station expects to receive the pending feedback information in the designated slot and via the uplink resource indicated by the DCI. The problem arises when in the high frequency operations (e.g., above 52.6 GHz), the wireless device is configured with multi-PDSCH scheduling. For example, the wireless device may receive a DCI scheduling multiple downlink channels (PDSCHs), e.g., in consecutive slots. In some scenarios, for example to reduce a latency of feedback transmission and/or avoid HARQ process starvation due to the increased number of scheduled slots, the base station may allocate/indicate, via the DCI, two or more PUCCHs for feedback transmission of the multiple scheduled downlink channels. For example, the multi-PDSCH scheduling DCI may indicate a first slot comprising a first PUCCH for HARQ feedback of one or more first PDSCHs of the multiple PDSCHs, and a second slot comprising a second PUCCH for HARQ feedback of one or more second PDSCHs of the multiple PDSCHs.

In such scenarios, if the wireless device has a pending feedback information, the wireless device may not be able to determine a certain/correct slot/sub-slot for transmitting the pending feedback information based on the existing technology. This may result in an ambiguity/misunderstanding between the wireless device and the base station regarding the time and resource where the pending feedback information is transmitted. As a result, HARQ performance may be degraded and retransmissions of the downlink channels may be needed, which may reduce the throughput of the network, and may increase power consumption of the wireless device as well as a latency of the downlink communications which is a serious problem especially for URLLC applications and services. There is a need for a mechanism based on which the wireless device may be able to select/determine a designated/correct slot and a respective uplink (PUCCH) resource for efficient transmission of the pending feedback information.

In an example, the wireless device may select the earliest (e.g., first) slot/sub-slot/PUCCH resource from a plurality of slots/sub-slots/PUCCH resources indicated by a multi-PDSCH scheduling DCI for a pending HARQ feedback transmission. However, the earliest slot/PUCCH may not necessarily be associated with same physical characteristics as the pending feedback information, and thus, there may be issue in successful transmission of the pending feedback information. For example, the pending feedback information may be associated with a first PHY priority, but the earliest slot/PUCCH may be associated with a second PHY priority. However, for enhanced reliability, the wireless device may not multiplex feedback codebooks of different priorities in a same PUCCH. As a result, the pending feedback information may be dropped/cancelled, and further retransmissions may be needed. In another example, the pending feedback information may be associated with a first subset of cells and/or HARQ processes and/or SPS configurations and/or codebook configurations, but the earliest slot/PUCCH may be associated with a second subset of cells and/or HARQ processes and/or SPS configurations and/or codebook configurations. However, for efficiency reasons, the wireless device may not multiplex feedback codebooks of different subsets in a same PUCCH, e.g., to avoid increased codebook size and overhead. In another example, the pending feedback information may be associated with a first beam and/or first transmit/receive point (TRP) and/or first transmission configuration indication (TCI), but the earliest slot/PUCCH may be associated with a second beam and/or second TRP and/or second TCI. Thus, it may not be possible for the wireless device to use the earliest slot/PUCCH to transmit the pending feedback information. For example, due to a non-idea backhaul, the wireless device may not transmit a pending feedback information of the first TRP to a second TRP. Therefore, a more efficient and flexible mechanism is needed to enable the wireless device to select/determine a suitable/correct slot/sub-slot/PUCCH resource, from the plurality of slots/sub-slots/PUCCH resources indicated by a DCI, for the pending feedback transmission. Embodiments may enable/increase a flexibility of the multi-PDSCH scheduling (e.g., in scheduling PDSCHs via a plurality of TRPs, cells, HARQ processes, etc.), while a mutual understanding of the resource used for a pending/deferred HARQ feedback transmission is maintained between the wireless device and the base station. Embodiments may enhance a HARQ performance in high frequency operations.

Per one or more embodiments of the present disclosure, a wireless device may receive one or more RRC messages from a base station. The one or more RRC messages may comprise configuration parameters indicating PDCCH monitoring occasions associated with a first CORESET. The configuration parameters may indicate resources of the first CORESET. The wireless device may monitor the PDCCH monitoring occasions for a first DCI format (e.g., DCI format 1_0, and/or DCI format 1_1, and/or DCI format 2_1).

The one or more RRC messages may comprise configuration parameters indicating PDSCH resources. For example, the configuration parameters may indicate one or more time domain resource allocation lists/tables (e.g., PDSCH-TimeDomainResourceAllocationList, PDSCH-TimeDomainResourceAllocationList-r16). A time domain resource allocation list may comprise one or more time domain resource allocations (TDRA). A TDRA entry may indicate a mapping type for the PDSCH and/or a time/slot offset from the scheduling DCI to the PDSCH and/or start symbol within the slot and/or a symbol duration and/or a repetition number (e.g., slot aggregation factor).

For example, the configuration parameters of the PDSCH may indicate whether a PHY priority indicator is present in the DCI format (e.g., DL scheduling DCI format 1_1 and/or format 1_2). The configuration parameters of the PDSCH may indicate a bit length/size of the PHY priority indicator in the DCI format.

The one or more RRC messages may comprise configuration parameters of PUCCH, indicating PUCCH resources. For example, the configuration parameters may indicate a list of timing for PDSCH to DL HARQ-ACK (e.g., dl-DataToUL-ACK). The wireless device may determine a HARQ feedback timing indicator value indicated by a scheduling DCI based on the list of timing values configured by the configurations parameters. The list of PDSCH to HARQ-ACK timings may comprise a first value (e.g., −1). The first value may be inapplicable/non-numerical. The first value may indicate that the HARQ-ACK timing is not explicitly included/indicated by the DCI at the time of scheduling the PDSCH.

The configuration parameters of PUCCH may indicate one or more spatial relation information (e.g., spatialRelationlnfoToAddModList, spatialRelationlnfoToAddModListSizeExt, spatialRelationInfoToAddModListExt). The spatial relation information may comprise/indicate configuration of the spatial relation between a reference signal (RS) and PUCCH. The RS may be SSB/CSI-RS/SRS. In an example, if the list has more than one element, a MAC-CE may select/indicate a single element to the wireless device.

The configuration parameters of PUCCH may indicate sub-slot length for sub-slot based PUCCH feedback, e.g., in number of symbols. The configuration parameters of PUCCH may indicate one or more PUCCH resource sets, each comprising one or more PUCCH resources. The configuration parameters may indicate for a PUCCH resource: a PUCCH resource ID, a starting PRB, whether intra-slot frequency hopping for the PUCCH resource is enabled, a second-hop PRB, and a PUCCH format. A PUCCH format may indicate a number of symbols for the PUCCH resource, and/or a starting symbol index within a slot, and/or a number of PRBs, etc.

The configuration parameters may indicate one or more HARQ-ACK codebooks (e.g., pdsch-HARQ-ACK-Codebook, pdsch-HARQ-ACK-Codebook-r16, pdsch-HARQ-ACK-CodebookList-r16) for PDSCH. For example, the PDSCH HARQ-ACK codebook may be semi-static (Type 1) and/or dynamic (Type 2) and/or enhanced dynamic (eType 2). The configuration parameters may indicate whether a one-shot HARQ-ACK (Type 3) is configured/enabled or not (e.g., pdsch-HARQ-ACK-OneShotFeedback-r16). For example, when configured, a DCI (e.g., DCI_format 1_1) may request the UE to report HARQ-ACK for all HARQ processes and all component carriers (CCs) configured in the PUCCH group. For example, the configuration parameters may indicate that a one-shot (Type 3) or an enhanced one-shot (eType 3) codebook is configured. For example, when enhanced one-shot codebook is configured, the DCI may request the UE to report HARQ-ACK for a subset of HARQ processes and/or a subset of CCs.

The wireless device may receive a first DCI based on the first DCI format via/using the PDCCH monitoring occasions. The first DCI may schedule a transport block (TB) reception using a first downlink channel. For example, the first DCI may schedule a first PDSCH comprising a first TB. The first TB may be associated with a first DL HARQ process. For example, the DCI may comprise an information field indicating the HARQ process number/ID of the first TB.

In an example, the first DCI may comprise/schedule one or more SPS configuration activation. In an example, the first DCI may comprise/schedule one or more SPS configuration release.

The first DCI may comprise a feedback timing indicator (e.g., PDSCH-to-HARQ_feedback timing indicator field). The feedback timing indicator may indicate a non-numerical/inapplicable value for the HARQ feedback transmission. The first DCI may not comprise a feedback timing indicator. Based on the feedback timing indicator in the DCI and/or the RRC configuration parameters indicating a list of timings for HARQ feedback, the wireless device may determine to postpone/defer the transmission of the first HARQ feedback information associated with the first DCI and/or the first TB and/or the first PDSCH reception. The wireless device may determine to wait until an indication/trigger is for transmitting the pending/postponed/deferred HARQ feedback information is received.

For example, the wireless device may transmit the first HARQ feedback information based on a second DCI. The wireless device may receive the second DCI after the first DCI. The second DCI may comprise a second HARQ feedback timing indicator, indicating a numerical/applicable value. The second feedback timing indicator may indicate a second slot for HARQ feedback transmission. The second DCI may indicate an uplink channel (e.g., PUCCH) resource for transmission of the pending HARQ feedback information.

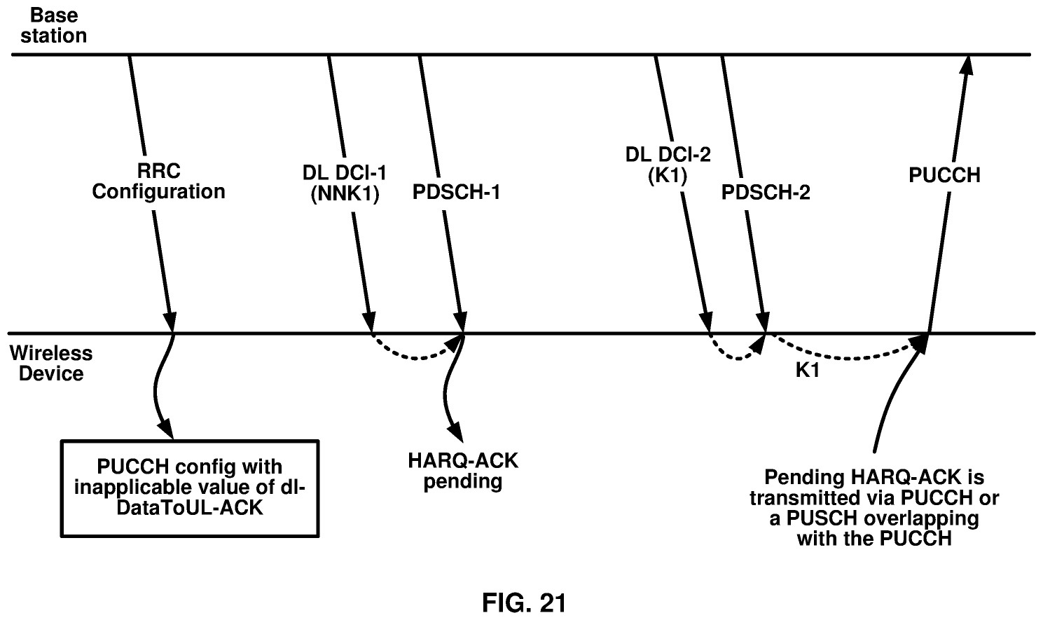

FIG. 21 illustrates an example of transmitting a pending HARQ feedback information, according to some embodiments. As shown in the figure, the UE may receive an RRC message indicating that a non-numerical/inapplicable HARQ feedback timing (NNK1) is configured, enabling postponing/deferring HARQ feedbacks until an uplink resource is indicated. The UE may receive a first DCI (DL DCI-1 in the figure), scheduling a first PDSCH (PDSCH-1). The first DCI may indicate a NNK1 value for the first PDSCH. In response to the NNK1 value, the HARQ feedback of the first PDSCH may be pending until a second DCI is received. The UE may receive a second DCI (e.g., DL DCI-2 in the figure), scheduling a second PDSCH (PDSCH-2). The second DCI may indicate a numerical/applicable HARQ feedback timing value (K1). The UE may determine a slot based on K1, e.g., K1 slots after a slot where the second PDSCH is received. The UE may determine a PUCCH resource in the determined slot, e.g., based on the second DCI (e.g., PRI in DCI-2) and/or RRC configuration parameters (e.g., PUCCH-ResourceSet). The UE may multiplex a HARQ feedback codebook in the determined PUCCH resource. The HARQ feedback codebook may comprise the pending/postponed/deferred HARQ-ACK information associated with the first PDSCH. The HARQ feedback codebook may comprise second HARQ-ACK of the second PDSCH. The UE may transmit the pending HARQ ACK in the slot indicated by the second DCI, via the determined PUCCH or a PUSCH that overlaps with the determined PUCCH.

In an example, the UE may assume a non-numerical/inapplicable HARQ feedback timing value for a HARQ feedback information. For example, the UE may not receive a DCI indicating non-numerical/inapplicable HARQ feedback timing value for the HARQ feedback information. For example, UE may receive a DCI associated with the HARQ feedback information, wherein the DCI may indicate a numerical/applicable HARQ feedback timing value.

The UE may determine the non-numerical/inapplicable HARQ feedback timing value for the HARQ feedback information based on one or more conditions/parameters/events. For example, if a first transmission of the HARQ feedback information is failed using a first (initial/original) PUCCH resource, e.g., indicated by a DCI, the UE may assume/consider the HARQ feedback information to be associated with a non-numerical/inapplicable HARQ feedback timing value. The first transmission of the HARQ feedback information may fail in response to a failure of a Listen-Before-Talk (LBT) procedure. The first transmission of the HARQ feedback information may fail in response to the first PUCCH resource collision/overlap with at least one DL/SSB/CORESET #0 symbol. For example, the UE may not transmit the HARQ feedback information if the first PUCCH resource collides/overlaps with at least one DL/SSB/CORESET #0 symbol. The first transmission of the HARQ feedback information may fail in response to the first PUCCH resource collision/overlap with a higher priority uplink transmission. For example, the UE may not transmit the HARQ feedback information if the first PUCCH resource comprises/collides/overlaps with a second UL transmission, wherein a second priority of the second UL transmission is higher than the first priority of the HARQ feedback information/first PUCCH transmission. The first transmission of the HARQ feedback information may fail in response to receiving a second DCI indicating an uplink cancellation associated with/overlapped with the first PUCCH resource.

Throughout this disclosure, the term “pending HARQ feedback information” may refer to following examples: A NNK1 HARQ feedback timing and/or a deferred HARQ feedback due to collision in TDD system and/or a dropped/cancelled HARQ feedback due to PHY prioritization/cancellation.

A NNK1 HARQ feedback timing: The UE may receive a first DCI. The first DCI may schedule at least one PDSCH reception. The first DCI may schedule activation of at least one SPS configuration. The first DCI may schedule release of at least one SPS configuration. The first DCI may comprise a HARQ feedback timing indicator field. The HARQ feedback timing indicator field may indicate an inapplicable/non-numerical value (NNK1). The inapplicable/non-numerical value of the HARQ feedback timing indicator may not indicate a PUCCH resource for transmitting HARQ feedback information associated with the first DCI and/or the at least one PDSCH. The first DCI may not trigger a PUCCH transmission comprising the HARQ feedback information. The inapplicable/non-numerical value of the HARQ feedback timing indicator may indicate to the UE to postpone/defer the transmission of the HARQ feedback information until a PUCCH resource is indicated. The HARQ feedback information may be pending to be transmitted via an indicated PUCCH resource. For example, the UE may receive a second DCI indicating the PUCCH resource. The UE may transmit the (pending) HARQ feedback information via the indicated PUCCH resource. The UE may receive an RRC parameter indicating that the HARQ feedback deferral based on NNK1 is enabled.

A deferred HARQ feedback due to collision in TDD system: A UE may be operating in a TDD system. The UE may receive one or more messages/signals indicating slot/symbol directions. A symbol direction may comprise UL or DL or flexible (to be determined later whether UL or DL). In an example, the UE may receive a first DCI. The first DCI may schedule at least one PDSCH reception. The PDSCH reception may be associated with a first SPS configuration. The first DCI may schedule activation of at least one SPS configuration. The first DCI may schedule release of at least one SPS configuration. The first DCI may comprise a HARQ feedback timing indicator field. The HARQ feedback timing indicator field may indicate a numerical/applicable value. The UE may determine a slot based on the HARQ feedback timing indicator. The UE may determine a PUCCH resource in the slot for transmitting HARQ feedback information of the first DCI and/or the at least one PDSCH. The UE may determine that the PUCCH resource overlaps/collides with at least one invalid symbol. An invalid symbol may be a DL and/or flexible symbol. An invalid symbol may be allocated to SSB and/or CORESET #0 transmission. The UE may not transmit the PUCCH and/or the HARQ feedback information in response to the collision with the at least one invalid symbol. The HARQ feedback information may be pending to be transmitted via an indicated valid PUCCH resource. The UE may postpone/defer the transmission of the HARQ feedback information until a valid PUCCH resource is indicated. For example, the UE may receive a second DCI indicating the PUCCH resource. The UE may determine whether the indicated PUCCH resource is valid or not, e.g., whether it overlaps with at least one invalid symbol, or not. The UE may transmit the (pending) HARQ feedback information via the indicated PUCCH resource. The UE may receive an RRC parameter indicating that the HARQ feedback deferral based on TDD collision is enabled.

A dropped/cancelled HARQ feedback due to PHY prioritization/cancellation: In an example, the UE may receive a first DCI. The first DCI may schedule at least one PDSCH reception. The PDSCH reception may be associated with a first SPS configuration. The first DCI may schedule activation of at least one SPS configuration. The first DCI may schedule release of at least one SPS configuration. The first DCI may indicate a PHY priority index for the at least one PDSCH reception. In an example, an RRC parameter may indicate a PHY priority index for PDSCHs associated with an SPS configuration. The first DCI may comprise a HARQ feedback timing indicator field. The HARQ feedback timing indicator field may indicate a numerical/applicable value. The UE may determine a slot based on the HARQ feedback timing indicator. The UE may determine a PUCCH resource in the slot for transmitting HARQ feedback information of the first DCI and/or the at least one PDSCH. The UE may determine that the slot and/or the PUCCH resource comprises uplink data and/or uplink control information of a higher priority. For example, the PUCCH resource may overlap with a second PUCCH and/or PUDSCH transmission of a second PHY priority, wherein the second priority is higher than the PHY priority of the HARQ feedback information. In an example, the UE may receive a second DCI indicating cancellation of UL transmission on at least one symbol of the PUCCH resource. The UE may not transmit the PUCCH and/or the HARQ feedback information in response to the collision/overlap with the higher priority UL transmission and/or the UL cancellation indication. The UE may cancel/drop the HARQ feedback information. The HARQ feedback information may be pending to be transmitted via an indicated PUCCH resource. The UE may postpone/defer the transmission of the HARQ feedback information until a PUCCH resource is indicated. For example, the UE may receive a third DCI indicating the PUCCH resource. The UE may transmit the (pending) HARQ feedback information via the indicated PUCCH resource, e.g., based on prioritization. The UE may receive an RRC parameter indicating that the HARQ feedback deferral based on prioritization/cancellation is enabled.

For example, the HARQ feedback information may be pending for (re)transmission. For example, the HARQ feedback information may be pending until a next PUCCH resource. For example, the HARQ feedback information may be pending until a second DCI is received that indicates PUCCH resource.

In an example, the UE may receive a second DCI after a first DCI wherein the first DCI indicates NNK1. The second DCI may trigger multiple (e.g., two or more) PUCCH transmissions. For example, the second DCI may comprise a field indicating multiple slots for HARQ feedback transmission. For example, the second DCI may comprise multiple HARQ feedback timing indicators indicating the multiple slots for HARQ feedback transmission. For example, the second DCI may comprise multiple PUCCH resource indicators (PRIs) corresponding to the multiple slots.

For example, the second DCI may indicate a first PUCCH resource in a first slot and a second PUCCH resource in a second slot. The first slot and/or the second slot may be corresponding to an active UL BWP of an UL carrier of a serving cell configured with PUCCH resources. The wireless device may transmit a first HARQ-ACK codebook via the first PUCCH resource in the first slot. The wireless device may transmit a second HARQ-ACK codebook via the second PUCCH resource in the second slot. The first HARQ-ACK codebook may comprise one or more first HARQ-ACK bits associated with one or more first PDSCHs and/or DCIs indicating SPS PDSCH releases. The second HARQ-ACK codebook may comprise one or more second HARQ-ACK bits associated with one or more second PDSCHs and/or DCIs indicating SPS PDSCH releases.

For example, the second DCI may schedule multiple PDSCHs (e.g., a multi-PDSCH scheduling DCI). The wireless device may receive an RRC message comprising configuration parameter(s) indicating that a DCI format may schedule multiple PDSCHs at the same time. For example, the configuration parameter(s) may indicate a TDRA table, wherein each row of the TDRA table indicates TDRA parameters of multiple PDSCHs. The multiple PDSCHs may be contiguous and/or non-contiguous. If configured, a DCI format may comprise a TDRA field pointing to a first row of the TDRA table. The UE may determine a number of scheduled PDSCHs from the number of (valid) entries of the indicated TDRA row/sequence. For example, a PDSCH may be valid if the symbols indicated by the respective TDRA parameters do not overlap with any UL/PRACH symbol.

The configuration parameters may indicate that the multi-PDSCH scheduling DCI format may trigger multiple PUCCH transmissions. The multiple PUCCH transmissions may comprise HARQ feedback information of the multiple PDSCHs scheduled by the DCI. For example, the DCI may indicate a first PUCCH resource for HARQ feedback of one or more first PDSCHs of the multiple PDSCHs. For example, the DCI may indicate a second PUCCH resource for HARQ feedback of one or more second PDSCHs of the multiple PDSCHs.

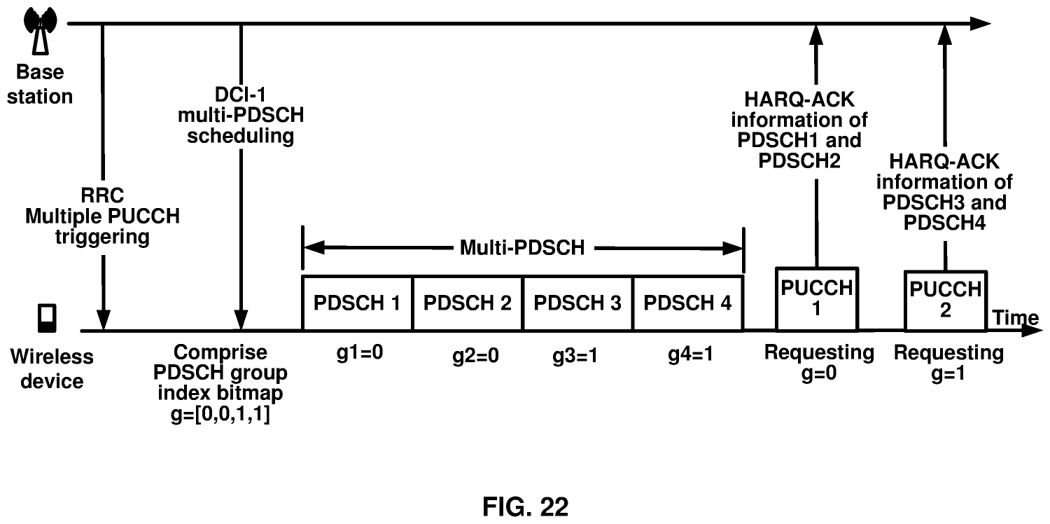

FIG. 22 illustrates as example of a DCI triggering multiple PUCCH transmissions, according to some embodiments. As shown in the figure, the UE may receive an RRC message indicating that a DCI may trigger multiple PUCCH transmissions. For example, the RRC message may indicate that a first HARQ-ACK codebook (e.g., enhanced Type 2) is configured. The UE may receive a DCI scheduling multiple PDSCHs (PDSCH-1 to PDSCH-4 in the figure). The DCI may indicate two slots-sub-slots each comprising a PUCCH resource (PUCCH-1 and PUCCH-2). Each PUCCH resource may be associated with/mapped to/scheduled for a subset of the multiple scheduled PDSCHs. The UE may transmit HARQ feedback of a first subset of PDSCHs via the first PUCCH and a second subset of PDSCHs via a second PUCCH.

In the example shown in the figure, PDSCH-1 and PDSCH-2 may be associated with PUCCH-1, and PDSCH-3 and PDSCH-4 may be associated with PUCCH-2. The association of the PDSCHs and the PUCCHs may be based on one or more parameters, e.g., indicated by the scheduling DCI.

For example, the UE may determine that a first PDSCH is mapped to a first PUCCH based on a time gap between the first PDSCH and the first PUCCH. For example, the time gap between PDSCH-3/PDSCH-4 and PUCCH-1 may not be above a threshold (e.g., PDSCH processing time), thus the UE may not report HARQ feedback of PDSCH-3/PDSCH-4 via PUCCH-1.

For example, the UE may determine that a first PDSCH is mapped to a first PUCCH based on a PDSCH group index. For example, the DCI may indicate that PDSCH-1 and PDSCH-2 are associated with a first PDSCH group (g1=g2=0). For example, the DCI may indicate that PDSCH-3 and PDSCH-4 are associated with a second PDSCH group (g3=g4=1). The DCI may indicate that PUCCH-1 is requesting/triggering HARQ feedback of the first PDSCH group (g=0) and/or that PUCCH-2 is requesting/triggering HARQ feedback of the second PDSCH group (g=1).

For example, the UE may determine that a first PDSCH is mapped to a first PUCCH based on a priority index. For example, the DCI may indicate a first priority index for PDSCH-1 and PDSCH-2 and/or PUCCH-1, and/or a second priority index for PDSCH-3 and PDSCH-4 and/or PUCCH-2.

For example, the UE may determine that a first PDSCH is mapped to a first PUCCH based on a beam/TCI state. For example, the DCI may indicate a first beam/TCI state for PDSCH-1 and PDSCH-2, and/or a second beam/TCI state for PDSCH-3 and PDSCH-4. The UE may map/report HARQ-ACK of PDSCHs associated with first beam(s)/TCI state(s) to PUCCH-1. The UE may map/report HARQ-ACK of PDSCHs associated with second beam(s)/TCI state(s) to PUCCH-2.

For example, the UE may determine that a first PDSCH is mapped to a first PUCCH based on a CORESET pool index. For example, the DCI may indicate a first CORESET pool index for PDSCH-1 and PDSCH-2 and/or PUCCH-1, and/or a second CORESET pool index for PDSCH-3 and PDSCH-4 and/or PUCCH-2.

The wireless device may have a pending HARQ-ACK information, e.g., associated with a first DCI indicating a non-numerical/inapplicable HARQ feedback timing (NNK1) value. The wireless device may receive a second DCI, e.g., after the first DCI. The second DCI may trigger multiple PUCCH transmissions. The wireless device may detect one or more DCIs from one or more PDCCH monitoring occasions, e.g., overlapping PDCCH monitoring occasions of two search spaces, indicating multiple PUCCH resources. For example, the second DCI may indicate multiple slots/sub-slots comprising PUCCH resources for multiple HARQ feedback transmissions. The wireless device may select a first slot/sub-slot from the multiple slots/sub-slots indicated by the second DCI for the pending HARQ-ACK information. For example, the wireless device may select a first PUCCH resource from the plurality of PUCCH resources indicated by the second DCI to transmit the pending HARQ-ACK information. The wireless device may determine/select the first slot/sub-slot and/or the first PUCCH resource based on a rule/criteria/parameter.

The wireless device may select a first PUCCH resource, of the plurality of PUCCH resources indicated by a second DCI, for transmission of a pending/deferred HARQ feedback information. The pending/deferred HARQ feedback information may be associated with a first DCI, e.g., scheduling a PDSCH and/or SPS PDSCH activation/release. For example, the first DCI may schedule a PDSCH corresponding to the pending HARQ feedback (e.g., based on a non-numerical K1 value). For example, the first DCI may schedule a SPS PDSCH activation/release corresponding to the pending HARQ feedback. The UE may select the first PUCCH based on the second DCI and/or the first DCI. The UE may select the first PUCCH based on at least one information field in the second DCI. The UE may select the first PUCCH based on at least one physical-layer parameter associated with the second DCI and/or the first PUCCH. The UE may select the first PUCCH based on at least the PDSCH and/or the first DCI corresponding to the pending HARQ feedback. The UE may select the first PUCCH based on at least one information field in the second DCI and the first DCI being the same/equal. As a result, base station and the wireless device may have a mutual understanding of the pending HARQ feedback transmission and HARQ codebooks while there are more than one PUCCH resources available/indicated to the UE by a same DCI and/or same/overlapping PDCCH monitoring occasion(s).

For example, the UE may select the first PUCCH based on at least one HARQ feedback timing indicator field in the second DCI. For example, a HARQ feedback timing indicator may indicate a first slot comprising the first PUCCH resource. In an example, the second DCI may comprise a second HARQ feedback timing indicator indicating a second slot comprising the second PUCCH resource. The first slot may be after a time gap from a first PDSCH/DCI associated with the pending/deferred HARQ feedback information. The time gap may be a PDSCH processing time. The time gap may be predefined, e.g., based on a UE capability and/or a numerology of a BWP/cell associated with the DCI/PDSCH(s). For example, the time gap may be configured by an RRC message.

In an example, the UE may select the earlier PUCCH resource from the multiple PUCCH resources indicated by the second DCI. For example, the UE may select the earlier PUCCH resource based on an earlier slot/sub-slot indicated by the second DCI for HARQ feedback transmission. For example, the UE may determine the earlier slot/sub-slot/PUCCH resource based on at least one TDRA value and/or at least one HARQ feedback timing indicator (K1 value) and/or at least one PRI.

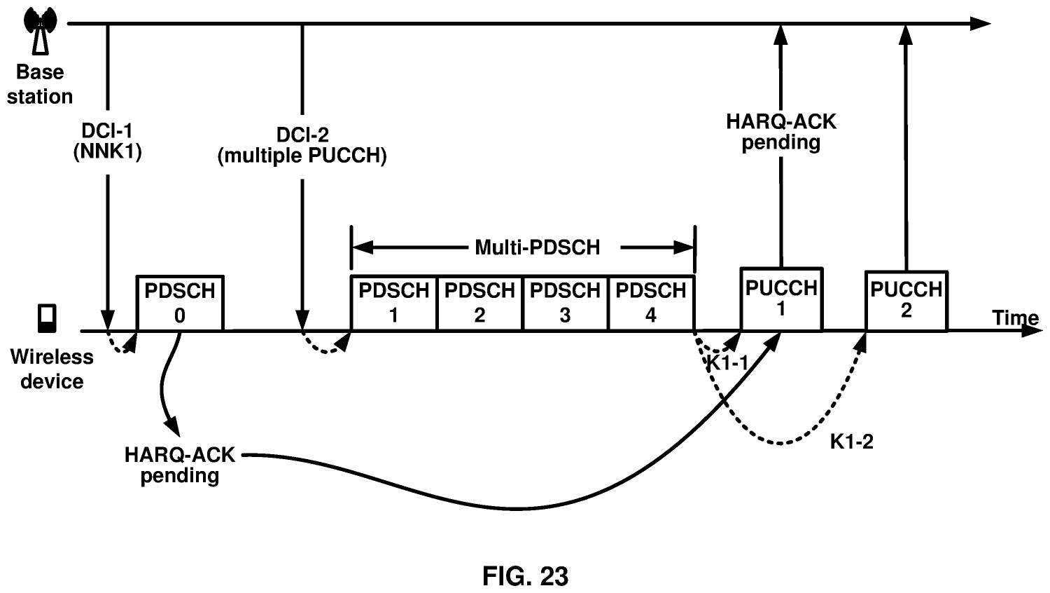

FIG. 23 illustrates an example of PUCCH selection for a pending HARQ feedback transmission, according to some embodiments. As shown in FIG. 23, the UE may have a pending HARQ feedback, associated with DCI-1 (e.g., indicating NNK1). The pending HARQ feedback may correspond to PDSCH-0 scheduled by DCI-1. The UE may DCI-2 scheduling multiple PDSCHs (PDSCH-1 to PDSCH-4). DCI-2 may indicate two slots/sub-slots comprising PUCCH resources for HARQ feedback transmission. For example, DCI-2 may comprise a first HARQ feedback timing indicator (k1-1) indicating a first slot/sub-slot comprising PUCCH-1. For example, DCI-2 may comprise a second HARQ feedback timing indicator (k1-2) indicating a second slot/sub-slot comprising PUCCH-2. The UE may select PUCCH-1 for the pending HARQ feedback transmission. For example, PUCCH-1 may be/start before/earlier than PUCCH-2. For example, the UE may determine the PUCCH resource for the pending HARQ feedback transmission based on the at least one HARQ feedback timing indicators in the second DCI. For example, the UE may select PUCCH-1 in response to the first HARQ feedback timing indicator (k1-1) being smaller than the second HARQ feedback timing indicator (k1-2). For example, the UE may select PUCCH-1 in response to the first HARQ feedback timing indicator (k1-1) and the second HARQ feedback timing indicator (k1-2) indicating that PUCCH-1 starts/ends earlier than PUCCH-2. The UE may multiple the pending HARQ feedback in a UCI of PUCCH-1. The UE may transmit the pending HARQ feedback via PUCCH-1 (or a PUSCH overlapped with PUCCH-1). For example, the UE may transmit the pending HARQ feedback and/or HARQ-ACK of PDSCH-1 and PDSCH-2 via PUCCH-1, and transmit HARQ-ACK of PDSCH-3 and PDSCH-4 via PUCCH-2.

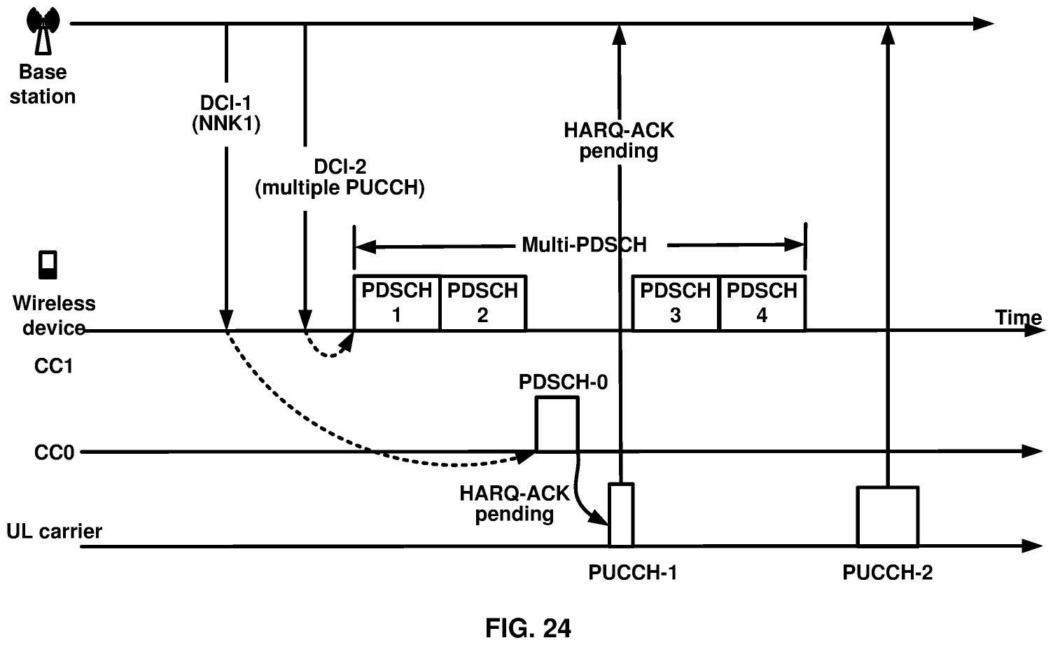

FIG. 24 illustrates an example of PUCCH selection for a pending HARQ feedback transmission in a carrier aggregation scenario, according to some embodiments. For example, as shown in the figure, UE may receive DCI-1 that may schedule PDSCH-0 for CC-0. UE may receive DCI-2 that scheduled multiple PDSCHs for CC-1. For example, the numerologies of CC-0 and CC-1 may be different. The multiple PDSCHs may or may not be contiguous. For example, as shown in the figure, the TDRA in the DCI may indicate that there is a gap between PDSCH-2 and PDSCH-3. The UE may receive PDSCH-0 scheduled by DCI-1 within the gap. DCI-1 may indicate a NNK1 for PDSCH-0. The UE may determine PUCCH-1 and PUCCH-2 based on DCI-2. The UE may determine based on the timing of PUCCH-1 and/or PUCCH-2 and/or based on the HARQ feedback timing indicators in DCI-2 to transmit the pending HARQ feedback via PUCCH-1. For example, PUCCH-1 may be within the processing time capability of the UE. For example, the UE may transmit the pending HARQ feedback and/or HARQ-ACK of PDSCH-1 and PDSCH-2 via PUCCH-1, and transmit HARQ-ACK of PDSCH-3 and PDSCH-4 via PUCCH-2.

In the example of FIG. 23 and/or FIG. 24, the UE may determine PUCCH-1 or PUCCH-2 for the pending HARQ feedback transmission, based on the order of PDSCHs, comprising PDSCH-0 and PDSCH-1 and PDSCH-2 and PDSCH-3 and PDSCH-4. The ordering of PDSCHs may be applied to PDSCHs associated with a same HARQ codebook, e.g., based on PHY priority and/or PDSCH group index and/or CORESET pool index. For example, the UE may not transmit the pending HARQ feedback via PUCCH-2 (the later PUCCH), if UE reports HARQ ACK of PDSCH-1 and PDSCH-2 via PUCCH-1 and/or receives PDSCH-0 after PDSCH-1 and PDSCH-2 and/or PDSCH-0 and PDSCH-1 and PDSCH-2 are associated with a same HARQ codebook. As a result, no ambiguity in the HARQ codebook generation may be expected.

In example of FIG. 23 and/or FIG. 24, the selection of PUCCH-1 from among PUCCH-1 and PUCCH-2 may be based on one or more other parameters/information indicated by the second DCI for PUCCH-1 and/or PUCCH-2. For example, the selection of PUCCH-1 may be based on at least one of the following information/parameters indicated by the second DCI: HARQ feedback timing indicator(s) (K1, K1-1, K1-2); TDRA; priority indicator/index; PDSCH group index; requested PDSCH group; TCI state and/or beam/spatial relation info; requested HARQ codebook; DAI and/or NFI; PUCCH group index; HARQ process number; etc.

The wireless device may have a pending/deferred HARQ feedback information. The wireless device may determine/select a first PUCCH resource, of the plurality of PUCCH resources indicated by a second DCI, for transmission of the pending/deferred HARQ feedback information. In an example, the first PUCCH and/or the first HARQ-ACK codebook associated with the first PUCCH may be associated with a first PHY priority (e.g., low/high priority). For example, the DCI (second DCI) may indicate that the first PUCCH/HARQ-ACK codebook is associated with a first priority index (e.g., 0/1). The UE may determine that the first PUCCH/HARQ-ACK is associated with the first priority index based on a priority indicator field in the DCI indicating a first value. For example, the second PUCCH and/or second HARQ-ACK codebook associated with the second PUCCH may be associated with a second PHY priority (e.g., high/low priority). For example, the DCI (second DCI) may indicate that the second PUCCH/HARQ-ACK codebook is associated with a second priority index (e.g., I/O). The UE may determine that the second PUCCH/HARQ-ACK is associated with the second priority index based on a priority indicator field in the DCI indicating a second value.

The UE may determine that the pending HARQ feedback information is associated with the first priority, e.g., based on a priority indicator in the first DCI. The UE may determine that the pending HARQ feedback information is associated with the first priority based on a DCI format of the first DCI. For example, the priority index may be pre-defined and/or pre-configured by RRC based on the DCI format and/or the PDSCH configuration. PHY priorities may depend on the service/application type of a data/transport block associated with the HARQ-ACK codebook and/or PUCCH transmission. The UE may select/determine a PUCCH resource, from the multiple PUCCH resources, that is associated with a same priority index as the pending HARQ feedback information.

The wireless device may select a first PUCCH resource from the plurality of PUCCH resources indicated by the second DCI to transmit the pending HARQ-ACK information. The first PUCCH may comprise a first HARQ-ACK codebook. In an example, the first PUCCH/HARQ-ACK codebook may be associated with a first PDSCH group. For example, the DCI (second DCI) may indicate that the first PUCCH/HARQ-ACK codebook is associated with a first PDSCH group (e.g., PDSCH group 0). The UE may determine that the first PUCCH/HARQ-ACK is associated with the first PDSCH group based on a PDSCH group index field and/or requested PDSCH group(s) field in the DCI indicating a first value. The DCI may comprise the PDSCH group index field and/or the requested PDSCH group(s) field, if the RRC configuration parameters indicate a first value (e.g., indicate that a first HARQ-ACK codebook (e.g., enhanced Type 2 CB) is configured). For example, the second PUCCH/HARQ-ACK codebook may be associated with a second PDSCH group. For example, the second DCI may indicate that the second PUCCH/HARQ-ACK codebook is associated with a second PDSCH group (e.g., PDSCH group 1). The UE may determine that the second PUCCH/HARQ-ACK is associated with the second PDSCH group based on a PDSCH group index field and/or requested PDSCH group(s) field in the DCI indicating a second value.

The UE may determine that the pending HARQ feedback information is associated with the first PDSCH group, e.g., based on a PDSCH group index in the first DCI. The UE may determine that the pending HARQ feedback information is associated with the first PDSCH group index based on a DCI format of the first DCI. For example, the PDSCH group index may be pre-defined and/or pre-configured by RRC based on the DCI format and/or the PDSCH configuration. PDSCH grouping may enable flexible DL scheduling while reducing a HARQ-ACK codebook size. The UE may select/determine a PUCCH resource, from the multiple PUCCH resources, that is associated with a same PDSCH group index as the pending HARQ feedback information.

The wireless device may select a first PUCCH resource from the plurality of PUCCH resources indicated by the second DCI to transmit the pending HARQ-ACK information. In an example, the first PUCCH resource/transmission may be associated with a first beam/TCI state/spatial relation information. For example, the second DCI may indicate that the first PUCCH and/or one or more first PDSCHs scheduled by the second DCI are associated with a first beam/TCI state/spatial relation information. For example, the one or more first PDSCHs may be a subset of multiple PDSCH scheduled by the second DCI. For example, the one or more first PDSCHs may be mapped to/reported via the first PUCCH. The UE may determine that the first PUCCH is associated with the first beam/TCI state/spatial relation information based on an SRS request field in the DCI indicating a first value and/or indicating an associated RS (e.g., CSI-RS). The UE may determine that the first PUCCH is associated with the first beam/TCI state/spatial relation information based on a spatial relation information configured by RRC parameters for the PUCCH resources comprising the first PUCCH resource. The UE may determine that the first PUCCH is associated with the first beam/TCI state/spatial relation information based on a TCI state of the one or more first PDSCHs, indicated by the second DCI. In an example, the second PUCCH resource/transmission may be associated with a second beam/TCI state/spatial relation information. For example, the second DCI may indicate that the second PUCCH and/or one or more second PDSCHs scheduled by the second DCI are associated with a second beam/TCI state/spatial relation information. For example, the one or more second PDSCHs may be a subset of multiple PDSCH scheduled by the second DCI. For example, the one or more second PDSCHs may be mapped to/reported via the second PUCCH. The UE may determine that the second PUCCH is associated with the second beam/TCI state/spatial relation information based on an SRS request field in the DCI indicating a second value and/or indicating an associated RS (e.g., CSI-RS). The UE may determine that the second PUCCH is associated with the second beam/TCI state/spatial relation information based on a spatial relation information configured by RRC parameters for the PUCCH resources comprising the second PUCCH resource. The UE may determine that the second PUCCH is associated with the second beam/TCI state/spatial relation information based on a TCI state of the one or more second PDSCHs, indicated by the second DCI.

The UE may determine that the pending HARQ feedback information is associated with a third beam/TCI state/spatial relation information, e.g., based on one or more fields in the first DCI and/or one or more RRC configured parameters. The UE may determine that the pending HARQ feedback information is associated with the third beam/TCI state/spatial relation information based on a DCI format of the first DCI. For example, the beam/TCI state/spatial relation information may be pre-defined and/or pre-configured by RRC based on the DCI format and/or the PDSCH configuration and/or the HARQ codebook configuration. Beam alignment may be essential for an efficient and successful communication, especially in higher frequencies. The UE may select/determine a PUCCH resource, from the multiple PUCCH resources, based on determining that the beam/TCI state/spatial relation information of the PUCCH is same/equal to and/or associated with the same beam/TCI state/spatial relation information as the pending HARQ feedback information.

The wireless device may be served by multiple TRPs. The multiple TRPs may operate/schedule/communicate separately and/or independently, e.g., due to a non-ideal backhaul. For example, the UE may receive an RRC message comprising a parameter indicating that separate HARQ codebooks may be generated/reported. For example, each HARQ codebook may be associated with a TRP/CORESET pool.

The wireless device may have a pending/deferred HARQ feedback information, associated with a first DCI. For example, the wireless device may receive the first DCI from a first TRP. For example, the wireless device may receive the first DCI via a PDCCH associated with a first CORESET pool index. The first CORESET pool may be associated with the first TRP.

The wireless device may receive a second DCI indicating multiple PUCCH resources for HARQ feedback transmission. For example, the wireless device may receive the second DCI from the first TRP or a second TRP. For example, the wireless device may receive the second DCI via a PDCCH associated with the first or a second CORESET pool index. The second DCI may indicate that each of the multiple PUCCH resources is associated with a respective TRP/CORESET pool. For example, the UE may determine that a first PUCCH resource is associated with a first CORESET pool index and/or that a second PUCCH resource is associated with a second CORESET pool index. The UE may determine the PUCCH resource association with the CORESET pool index based on a CORESET pool index of one or more PDSCHs scheduled by the second DCI.

The UE may select/determine a first PUCCH resource from the plurality of PUCCH resources indicated by the second DCI to transmit the pending HARQ-ACK information. Utilizing multiple TRPs may enable more reliable communications and/or higher throughput. The UE may select/determine a PUCCH resource, from the multiple PUCCH resources, that is associated with a same TRP/CORESET pool as the pending HARQ feedback information.

In an example, the UE may receive an RRC message comprising parameters indicating that a first HARQ codebook (e.g., enhanced Type 2 CB and/or enhanced Type 3 CB) is configured. For example, multiple applicable HARQ-ACK (sub-)codebooks may be configured if a first codebook is configured. In an example, each HARQ codebook may be associated with a subset of HARQ processes. In an example, each HARQ codebook may be associated with a subset of cells/serving cells. In an example, each HARQ codebook may be associated with a subset of PHY priorities and/or PDSCH groups. In an example, each HARQ codebook may be associated with a subset of SPS PDSCH configurations. A DCI scheduling a PDSCH and/or triggering a HARQ feedback transmission may indicate the applicable/associated HARQ (sub-)codebook from the multiple configured HARQ (sub-)codebooks.

For example, the UE may receive a first DCI indicating/associated with a pending HARQ feedback information (e.g., based on NNK1). The UE may determine that the pending HARQ feedback information is associated with the first HARQ codebook, e.g., based on a HARQ codebook index in the first DCI. The UE may determine that the pending HARQ feedback information is associated with the first HARQ codebook based on a DCI format of the first DCI. For example, the HARQ codebook may be pre-defined and/or pre-configured by RRC based on the DCI format and/or the respective PDSCH configuration.

The wireless device may receive a second DCI indicating multiple PUCCH resources for HARQ feedback transmission. The wireless device may select a first PUCCH resource from the plurality of PUCCH resources indicated by the second DCI to transmit the pending HARQ-ACK information. The first PUCCH may comprise a first HARQ-ACK codebook. In an example, the first PUCCH may be associated with the first HARQ-ACK codebook. For example, the second DCI may indicate that the first PUCCH is associated with a first HARQ-ACK codebook. The UE may determine that the first PUCCH is associated with the first HARQ-ACK codebook based on a predefined rule and/or an RRC parameter and/or a indication by the second DCI. For example, the second PUCCH may comprise/be associated with a second HARQ-ACK codebook. For example, the second DCI may indicate that the second PUCCH is associated with a second HARQ-ACK codebook. The UE may determine that the second PUCCH/HARQ-ACK is associated with the second PDSCH group based on a predefined rule and/or an RRC parameter and/or an indication by the second DCI.

Multiple applicable HARQ-ACK (sub-)codebooks may be beneficial for reducing a (one-shot) codebook size. The UE may select/determine a PUCCH resource, from the multiple PUCCH resources, that is associated with a same HARQ-ACK (sub-)codebook as the pending HARQ feedback information.

In an example, the UE may receive a second DCI, indicating a first PUCCH resource from a first PDCCH monitoring occasion, e.g., via a first search space. In an example, the UE may receive a third DCI, indicating a second PUCCH resource from a second PDCCH monitoring occasion, e.g., via a second search space. The first PDCCH monitoring occasion and the second PDCCH monitoring occasion may be the same. The first PDCCH monitoring occasion and the second PDCCH monitoring occasion may fully and/or partially overlap. The first PDCCH monitoring occasion and the second PDCCH monitoring occasion may start in a same symbol/at a same time. The first PDCCH monitoring occasion and the second PDCCH monitoring occasion may end in a same symbol/at a same time. The first search space and the second search space may be the same. The first search space and the second search space may be the associated with a same CORESET and/or CORESET pool. The first search space and the second search space may be the associated with different CORESETs and/or CORESET pools. For example, the first search space and/or the second DCI may be associated with a first CORESET/CORESET pool, and the second search space and/or the third DCI may be associated with a second CORESET/CORESET pool.

The UE, having a pending HARQ feedback information associated with a first DCI, may determine/select a PUCCH resource from the first PUCCH resource (indicated by the second DCI) and the second PUCCH resource (indicated by the third DCI). For example, the UE may select the PUCCH based on a PDCCH/search space configuration of the second DCI and/or the third DCI. For example, the UE may select the second PUCCH in response to receiving the first DCI and the third DCI from a same/overlapping CORSET/search space/PDCCH monitoring occasion. For example, the UE may select the PUCCH based on a CORESET pool index of the second DCI and/or the third DCI. For example, the UE may select the first PUCCH in response to determining that the first DCI and the second DCI are associated with/received from a same/overlapping CORSET pool.

In an example, RRC configuration may indicate which of the multiple PUCCH resources scheduled by a same DCI/PDCCH is used for a pending HARQ feedback transmission. For example, the UE may have a pending HARQ feedback information. The UE may receive an RRC message comprising configuration parameters. The configuration parameters may indicate that a DCI may indicate two or more PUCCH resources and/or trigger two or more PUCCH transmissions comprising HARQ feedback information. For example, at least one parameter of the configuration parameters may indicate whether the UE uses/selects a first PUCCH resource or a second PUCCH resource, of the two or more PUCCH resources indicated by a DCI, for the pending HARQ feedback transmission. For example, the at least one parameter may comprise a first value, indicating that the UE may select the first PUCCH resource. For example, the at least one parameter may comprise a second value, indicating that the UE may select the second PUCCH resource. The first PUCCH resource may be an earlier PUCCH resource. For example, the first PUCCH resource may start in a symbol before the start of the second PUCCH. The first PUCCH resource may be associated with a first (e.g., lower/higher) priority. The first PUCCH resource may be associated with a first CORESET pool index. The first PUCCH resource may be associated with a first HARQ (sub-)codebook. For example, the first PUCCH may be associated with a first subset of HARQ processes and/or cells/serving cells and/or (SPS) PDSCH configurations and/or PUCCH resource set/configurations/groups and/or PDSCH groups. For example, the UE may select the first PUCCH in response to the first PUCCH resource comprising more number of symbols/sub-slots/PRBs compared to the second PUCCH resource indicated by the (same) DCI/PDCCH.

In an example, the UE may select the first PUCCH resource for a pending HARQ feedback information based on a predefined rule. For example, the UE may select the first/earliest PUCCH resource indicated by a DCI.

In an example, the UE may receive a second DCI, e.g., after a first DCI associated with a pending HARQ feedback information. The second DCI may or may not schedule a PDSCH. For example, the second DCI may trigger one or more HARQ-ACK codebook transmissions. For example, the UE may receive RRC configuration parameters indicating two or more HARQ-ACK codebooks, e.g., for a first type codebook (enhanced Type 3). For example, each HARQ-ACK codebook may comprise HARQ feedback information of a subset of PDSCHs. For example, a first HARQ-ACK codebook may be associated with a first subset of DL HARQ processes/cells/serving cells/SPS configurations/PDSCH configurations. For example, a second HARQ-ACK codebook may be associated with a second subset of DL HARQ processes/cells/serving cells/SPS configurations/PDSCH configurations.

For example, the second DCI may indicate a first slot comprising a first PUCCH resource, and/or a second slot comprising a second PUCCH resource. For example, the first PUCCH resource may comprise a first HARQ-ACK codebook. For example, the second PUCCH resource may comprise a second HARQ-ACK codebook. The UE may determine/map a HARQ-ACK codebook associated with a PUCCH resource based on a predefined rule and/or a pre-configured RRC parameter and/or an indication by the second DCI.

The UE may select one of the PUCCHs indicated by the second DCI to transmit a pending HARQ feedback information. For example, the UE may select/determine the first PUCCH resource indicated by the second DCI, based on the HARQ-ACK codebook configuration associated with/mapped to the first PUCCH resource. For example, the first PUCCH resource may comprise/be associated with a first HARQ-ACK codebook configuration. The pending HARQ feedback information and the first HARQ-ACK codebook may be associated with a same codebook configuration. For example, a first subset of DL HARQ processes/cells/serving cells/SPS configurations/PDSCH configurations may comprise both the pending HARQ feedback information and the first HARQ-ACK codebook of the first PUCCH. For example, the second PUCCH, comprising a second HARQ-ACK codebook, may not be associated with the pending HARQ feedback information.

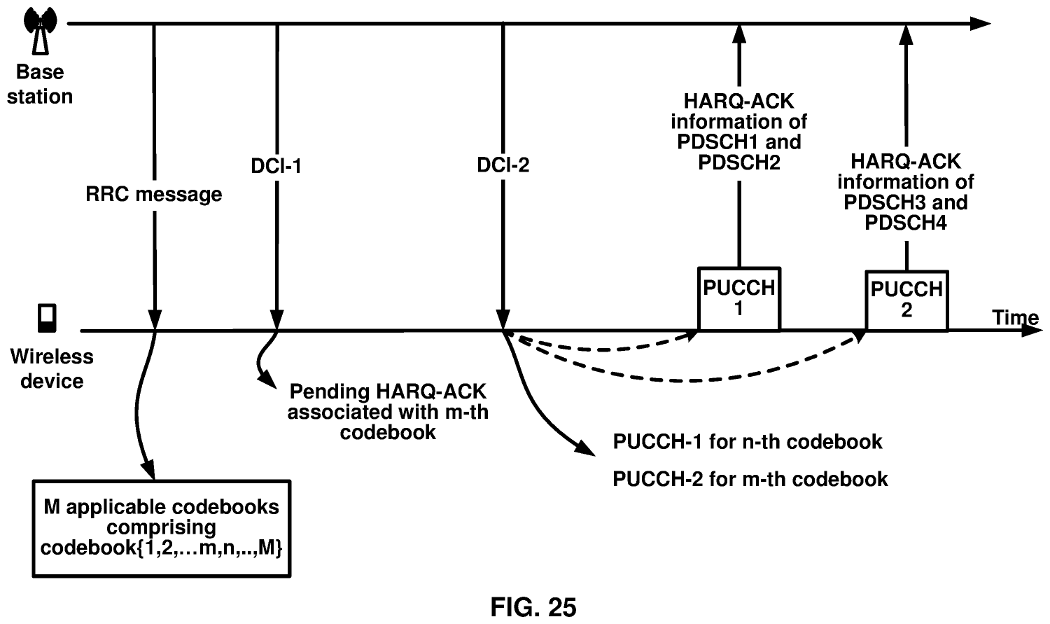

FIG. 25 illustrates an example of PUCCH selection for a pending HARQ feedback transmission with multiple applicable HARQ-AKC codebooks, according to some embodiments. As shown in FIG. 25, the UE may receive an RRC message configurating multiple (M) applicable HARQ-ACK codebooks (e.g., enhanced Type 3 codebooks). Each codebook may be applicable to/associated with a subset of DL HARQ processes/cells/serving cells/SPS configurations/PDSCH configurations. The UE may have/determine a pending HARQ feedback information, associated with DCI-1. The UE may determine, based on one or more RRC parameters and/or one or more information fields in DCI-1 and/or a PDSCH schedule by DCI-1, that the pending HARQ feedback information is associated with a first applicable/configured codebook (e.g., m-th codebook).

A shown in example, of FIG. 25, the UE may receive DCI-2 indicating two PUCCH resources for HARQ feedback transmission. The UE may determine, based on one or more RRC parameters and/or one or more information fields in DCI-2, that the first PUCCH resource is associated with a second applicable/configured codebook (e.g., n-th codebook), and/or that the second PUCCH resource is associated with the first applicable/configured codebook (e.g., m-th codebook). The UE may select the second PUCCH (PUCCH-2) for transmission of the pending HARQ feedback information based on the applicable codebook. For example, the UE may transmit the pending HARQ feedback information via the second PUCCH in response to determining that the pending HARQ feedback information and the second PUCCH are associated with a same/overlapped applicable codebook configured by RRC. For example, the UE may determine that the first PUCCH (PUUCH-1) is not associated with a same applicable codebook as the pending HARQ feedback information.

In an example, PUCCH-1 and PUCCH-2 may be indicated/triggered by different DCIs. For example, UE may receive DCI-2 indicating PUCCH-1. The UE may receive DCI-3 indicating PUCCH-2. The UE may determine, based on one or more RRC parameters and/or one or more information fields in DCI-2, that the first PUCCH resource is associated with a second applicable/configured codebook (e.g., n-th codebook). The UE may determine, based on one or more RRC parameters and/or one or more information fields in DCI-3, that the second PUCCH resource is associated with the first applicable/configured codebook (e.g., m-th codebook). The UE may select the second PUCCH (PUCCH-2) for transmission of the pending HARQ feedback information based on the applicable codebook.

In an example, the UE may receive configuration parameters indicating that a first HARQ-ACK codebook (e.g., semi-static Type 1 and/or dynamic Type 2 and/or enhanced dynamic Type 2 and/or one-shot Type 3 and/or enhanced one-shot Type 3) is configured. The configuration parameters may indicate that an information field (e.g., Downlink Assignment Index—DAI), associated with the first HARQ-ACK codebook, in a DCI format is present and/or that a size/bit length of the information field in the DCI format is increased. For example, if a first parameter is not present in the configuration parameters and/or if the first parameter takes/indicates a first value, the UE may determine a first size/length for the information field in the DCI format. For example, if a second parameter is not present in the configuration parameters and/or if the first/second parameter takes/indicates a second value, the UE may determine a second size/length for the information field in the DCI format.

The information field may comprise/indicate one or more DAI values (e.g., total-DAI and/or counter-DAI) associated with one or more PDSCHs. The one or more PDSCHs may be scheduled by the DCI format. The DCI format may be a non-fallback DCI format (e.g., DCI format 1_1 and/or DCI format 2_1). For example, a first DCI may comprise a DAI field based on a first size/bit length. For example, the first DCI may schedule a single PDSCH for a first cell/serving cell. For example, the UE may receive the first DCI from a first cell/cell group. For example, a second DCI may comprise a DAI field based on a second size/bit length. For example, the first DCI may schedule multiple PDSCHs for a second cell/serving cell. For example, the UE may receive the second DCI from a second cell/cell group. The first cell/serving cell/cell group and the second cell/serving cell/cell group may be the same. The cells in a same cell group may be associated with a same HARQ-ACK (sub-)codebook, e.g., may share a same DAI counting procedure/format/size. For example, RRC parameter(s) may indicate which cells belong to a same cell group. The second size/bit length may be larger than the first size/bit length (e.g., more than 2 bits).

In an example, the size/bit length of the DAI field in a DCI format may be determined/configured based on a scheduling mode. For example, if a first scheduling mode is configured (e.g., single-PDSCH scheduling mode), then the DAI field in a DCI format may comprise X bits. For example, if a second scheduling mode is configured (e.g., multi-PDSCH scheduling mode), then the DAI field in the DCI format may comprises Y bits (e.g., Y>=X). Each scheduling mode may correspond to a separate/different HARQ-ACK (sub-)codebook. Each HARQ-ACK codebook may be controlled by and/or determined based on a separate/different DAI format/size/bit length.

For example, different HARQ-ACK codebooks may have different DAI counting procedure, and thus, different DAI format/size/bit length. For example, the UE may determine a first HARQ-ACK codebook based on a first (e.g., legacy) DAI counting procedure, e.g., based on a first DCI format indicating the DAI and/or based on an RRC parameter. For example, the UE may determine a second HARQ-ACK codebook based on a second (e.g., enhanced) DAI counting procedure, e.g., based on a second DCI format indicating the DAI and/or based on the RRC parameter.

In an example, the UE may receive a first DCI. The UE may determine a pending HARQ feedback information based on the first DCI. For example, the first DCI may indicate a NNK1 value. For example, the first DCI may schedule one or more PDSCHs, e.g., based on a first scheduling mode. The first DCI may comprise a first field, e.g., DAI field, indicating a first value. The first DAI field in the first DCI may correspond to a first format/size/bit length/index. The first DCI may correspond to a first scheduling mode. The first DCI may correspond to a first HARQ-ACK (sub-)codebook. The first HARQ-ACK (sub-)codebook may be associated with the first format/size/bit length/index of DAI field. For example, the UE may determine the first HARQ-ACK (sub-)codebook based on the first DAI, in response to the first DAI being based on the first format/size/bit length/index.

The UE may receive a second DCI. The second DCI may schedule one or more PDSCHs, e.g., based on a second scheduling mode. The second DCI may comprise a second field, e.g., DAI field, indicating a second value. The second DAI field in the second DCI may correspond to a second format/size/bit length/index. The second DCI may correspond to a second scheduling mode. The second DCI may correspond to a second HARQ-ACK (sub-)codebook. The second HARQ-ACK (sub-)codebook may be associated with the second format/size/bit length/index of DAI field. For example, the UE may determine the second HARQ-ACK (sub-)codebook based on the second DAI, in response to the second DAI being based on the second format/size/bit length/index.

The second DCI may indicate at least one PUCCH resource and/or trigger at least one PUCCH transmission. The at least one PUCCH resource may comprise one or more HARQ-ACK codebooks. The UE may determine to transmit the pending HARQ feedback information via the at least one PUCCH resource. The UE may determine whether to transmit the pending HARQ-ACK information via the at least one PUCCH resource based on a first format of the first DCI and a second format of the second DCI. For example, the UE may transmit the pending HARQ feedback information via the at least one PUCCH resource if a DCI format of the first DCI and the second DCI are the same (e.g., both are fallback DCI and/or both are non-fallback DCI, e.g., format 1_1 and/or DCI 2_1). For example, the UE may not transmit the pending HARQ feedback information via the at least one PUCCH resource if a DCI format of the first DCI and the second DCI are not the same. For example, the UE may transmit the pending HARQ feedback information via the at least one PUCCH resource if the first DCI is based on a fallback DCI format and the second DCI is based on the fallback DCI format and/or a (any) non-fallback DCI format.

The UE may determine whether to transmit the pending HARQ-ACK information via the at least one PUCCH resource based on the first format/size/bit length/index of the first DAI field in the first DCI and/or the second format/size/bit length/index of the second DAI field in the second DCI. For example, the UE may transmit the pending HARQ feedback information via the at least one PUCCH resource if the first format/size/bit length/index of the first DAI field is the same as the second format/size/bit length/index of the second DAI field. For example, the UE may not transmit the pending HARQ feedback information via the at least one PUCCH resource if the first format/size/bit length/index of the first DAI field is not the same as the second format/size/bit length/index of the second DAI field. As a result, a HARQ-ACK codebook size may be determined correctly, and/or ambiguity in determining one or more HARQ-ACK codebooks may be reduced, because different DAI formats may control different HARQ-ACK codebooks.

The UE may determine whether to transmit the pending HARQ-ACK information via the at least one PUCCH resource based on the first scheduling mode of the first DCI and/or the second scheduling mode of the second DCI. For example, the UE may transmit the pending HARQ feedback information via the at least one PUCCH resource if the first scheduling mode is the same as the second scheduling mode, e.g., if both DCIs schedule single PDSCH and/or if both DCIs schedule multiple PDSCHs. For example, the UE may not transmit the pending HARQ feedback information via the at least one PUCCH resource if the first scheduling mode is not the same as the second scheduling mode.

The UE may determine whether to transmit the pending HARQ-ACK information via the at least one PUCCH resource based on a first cell/cell group of the first DCI and/or a second cell/group of the second DCI. For example, the UE may transmit the pending HARQ feedback information via the at least one PUCCH resource if the first cell/cell group is the same as the second cell/cell group, e.g., if both DCIs are received from same cell/cell group. For example, the UE may not transmit the pending HARQ feedback information via the at least one PUCCH resource if both DCIs are not received from same cell/cell group.

Throughout this disclosure, the terms HARQ-ACK and HARQ feedback may be used interchangeably.

What is claimed is:

1. A wireless device comprising:
one or more processors; and
memory storing instructions that, when executed by the one or more processors, cause the wireless device to:
receive, via a first control resource set (coreset) pool of a plurality of coreset pools, a first downlink control information (DCI) indicating no feedback timing for transmission of feedback information of the first DCI;
receive a second DCI indicating a first physical uplink control channel (PUCCH); and
transmit the feedback information of the first DCI via the first PUCCH, based on the first PUCCH being associated with the first coreset pool via which the first DCI is received.

2. The wireless device of claim 1, wherein the instructions, when executed by the one or more processors, further cause the wireless device to:
receive the first DCI from a first physical downlink control channel (PDCCH) monitoring occasion of a first search space associated with a first coreset, wherein the first coreset is associated with the first coreset pool.

3. The wireless device of claim 1, wherein the instructions, when executed by the one or more processors, further cause the wireless device to:
receive a radio resource control (RRC) message comprising a configuration parameter indicating that the first PUCCH is associated with the first coreset pool.

4. The wireless device of claim 3, wherein the instructions, when executed by the one or more processors, further cause the wireless device to:
receive the second DCI from a second physical downlink control channel (PDCCH) monitoring occasion of a second search space associated with a second coreset, wherein:
the second coreset is associated with the first coreset pool, and
the first PUCCH is associated with the first coreset pool based on the second DCI being received via the first coreset pool.

5. The wireless device of claim 1, wherein the instructions, when executed by the one or more processors, further cause the wireless device to:
receive a radio resource control (RRC) message comprising one or more parameters indicating:
a first coreset is associated with the first coreset pool and a second coreset is associated with a second coreset pool; and
configuration of a separate hybrid automatic repeat request acknowledgement (HARQ-ACK) mode corresponding to separate reporting of first HARQ-ACK information associated with the first coreset of the first coreset pool and second HARQ-ACK information associated with the second coreset of the second coreset pool.

6. The wireless device of claim 1, wherein:
the second DCI further indicates the first PUCCH being associated with the first coreset pool; and
the second DCI comprises a feedback timing indicator field indicating a slot comprising the first PUCCH.

7. The wireless device of claim 1, wherein the instructions, when executed by the one or more processors, further cause the wireless device to:
select the first PUCCH, from among the first PUCCH and a second PUCCH associated with a second coreset pool, and based on the first PUCCH being associated with the first coreset pool.

8. The wireless device of claim 7, wherein the second DCI indicates:
a plurality of time domain resources for a plurality of physical downlink shared channels (PDSCHs) across slots;
a first slot comprising the first PUCCH for transmitting first feedback information of one or more first PDSCHs, of the plurality of PDSCHs, that are associated with the first coreset pool, and
a second slot comprising the second PUCCH for transmitting second feedback information of one or more second PDSCHs, of the plurality of PDSCHs, that are associated with the second coreset pool.

9. A base station comprising:
one or more processors; and
memory storing instructions that, when executed by the one or more processors, cause the base station to:
transmit, to a wireless device and via a first control resource set (coreset) pool of a plurality of coreset pools, a first downlink control information (DCI) indicating no feedback timing for receiving feedback information of the first DCI;
transmit, to the wireless device, a second DCI indicating a first physical uplink control channel (PUCCH); and
receive, from the wireless device, the feedback information of the first DCI via the first PUCCH, based on the first PUCCH being associated with the first coreset pool via which the first DCI is transmitted.

10. The base station of claim 9, wherein the instructions, when executed by the one or more processors, further cause the base station to:
transmit the first DCI using a first physical downlink control channel (PDCCH) monitoring occasion of a first search space associated with a first coreset, wherein the first coreset is associated with the first coreset pool.

11. The base station of claim 9, wherein the instructions, when executed by the one or more processors, further cause the base station to:
transmit a radio resource control (RRC) message comprising a configuration parameter indicating that the first PUCCH is associated with the first coreset pool.

12. The base station of claim 11, wherein the instructions, when executed by the one or more processors, further cause the base station to:
transmit the second DCI using a second physical downlink control channel (PDCCH) monitoring occasion of a second search space associated with a second coreset, wherein:
the second coreset is associated with the first coreset pool; and
the first PUCCH is associated with the first coreset pool based on the second DCI being transmitted via the first coreset pool.

13. The base station of claim 9, wherein the instructions, when executed by the one or more processors, further cause the base station to:
transmit a radio resource control (RRC) message comprising one or more parameters indicating:
a first coreset is associated with the first coreset pool and a second coreset is associated with a second coreset pool; and
configuration of a separate hybrid automatic repeat request acknowledgement (HARQ-ACK) mode corresponding to separate reporting of first HARQ-ACK information associated with the first coreset of the first coreset pool and second HARQ-ACK information associated with the second coreset of the second coreset pool.

14. The base station of claim 9, wherein:
the second DCI indicates:
the first PUCCH being associated with the first coreset pool; and
a second PUCCH being associated with a second coreset pool; and
the second DCI comprises a feedback timing indicator field indicating a slot comprising the first PUCCH.

15. A non-transitory computer-readable medium comprising instructions that, when executed by one or more processors of a wireless device, cause the wireless device to:
receive, via a first control resource set (coreset) pool of a plurality of coreset pools, a first downlink control information (DCI) indicating no feedback timing for transmission of feedback information of the first DCI;
receive a second DCI indicating a first physical uplink control channel (PUCCH); and
transmit the feedback information of the first DCI via the first PUCCH, based on the first PUCCH being associated with the first coreset pool via which the first DCI is received.

16. The non-transitory computer-readable medium of claim 15, wherein the instructions, when executed by the one or more processors, further cause the wireless device to:
receive the first DCI from a first physical downlink control channel (PDCCH) monitoring occasion of a first search space associated with a first coreset, wherein the first coreset is associated with the first coreset pool.

17. The non-transitory computer-readable medium of claim 15, wherein the instructions, when executed by the one or more processors, further cause the wireless device to:
receive a radio resource control (RRC) message comprising a configuration parameter indicating the first PUCCH is associated with the first coreset pool.

18. The non-transitory computer-readable medium of claim 17, wherein the instructions, when executed by the one or more processors, further cause the wireless device to:
receive the second DCI from a second physical downlink control channel (PDCCH) monitoring occasion of a second search space associated with a second coreset, wherein:
the second coreset is associated with the first coreset pool, and
the first PUCCH is associated with the first coreset pool based on the second DCI being received via the first coreset pool.

19. The non-transitory computer-readable medium of claim 15, wherein the instructions, when executed by the one or more processors, further cause the wireless device to:
receive a radio resource control (RRC) message comprising one or more parameters indicating:
a first coreset is associated with the first coreset pool and a second coreset is associated with a second coreset pool; and
configuration of a separate hybrid automatic repeat request acknowledgement (HARQ-ACK) mode corresponding to separate reporting of first HARQ-ACK information associated with the first coreset of the first coreset pool and second HARQ-ACK information associated with the second coreset of the second coreset pool.

20. The non-transitory computer-readable medium of claim 15, wherein:
the second DCI indicates that the first PUCCH being associated with the first coreset pool;
the second DCI comprises a feedback timing indicator field indicating a slot comprising the first PUCCH; and
the instructions, when executed by the one or more processors, further cause the wireless device to:
select the first PUCCH, from among the first PUCCH and the second PUCCH associated with a second coreset pool, and based on the first PUCCH being associated with the first coreset pool.
